(19) United States
(12) Patent Application Publication
(10) Pub. No.: US 2022/0158173 A1
(43) Pub. Date: May 19, 2022

(54) MOF-SULFUR MATERIALS AND COMPOSITE MATERIALS, METHODS OF MAKING SAME, AND USES THEREOF

(71) Applicant: CORNELL UNIVERSITY, Ithaca, NY (US)

(72) Inventors: Héctor D. Abruña, Ithaca, NY (US); Na Zhang, Ithaca, NY (US)

(21) Appl. No.: 17/435,292

(22) PCT Filed: Mar. 9, 2020
(86) PCT No.: PCT/US20/21760

§ 371 Date: Aug. 31, 2021

Related U.S. Application Data
(60) Provisional application No. 62/815,253, filed on Mar. 7, 2019.

(51) Int. Cl. H01M 4/36; H01M 4/62; H01M 4/38; H01M 4/58; H01M 10/052; H01M 10/054

(52) U.S. Cl. CPC H01M 4/364; H01M 4/625; H01M 4/38; H01M 2004/028; H01M 10/052; H01M 10/054; H01M 4/5815

(57) ABSTRACT

MOFs including sulfur nanoparticles. The sulfur nanoparticles may be encapsulated in the MOFs. The MOFs may be made by methods where MOFs are formed in situ or are preformed prior to the incorporation of sulfur. The MOFs may be used to make composite materials. The composite materials may be used in cathodes. Cathodes may be used in devices. A device may be a battery.

### CROSS REFERENCE TO RELATED APPLICATIONS

This application claims priority to U.S. Provisional Application No. 62/815,253, filed on Mar. 7, 2019, the disclosure of which is incorporated herein by reference.

### STATEMENT REGARDING FEDERALLY SPONSORED RESEARCH

This invention was made with government support under DMR-1719875 and DMR-1332208 awarded by the National Science Foundation. The government has certain rights in the invention.

### FIELD OF THE DISCLOSURE

The disclosure generally relates to metal-organic framework-sulfur materials and related composite materials. More particularly, the disclosure generally relates to use of such materials as cathode materials.

### BACKGROUND OF THE DISCLOSURE

Lithium-sulfur (Li—S) batteries have been considered as one of the most promising next generation electrical energy storage systems due to their ultrahigh theoretical capacity (1675 mA h g⁻¹), low cost, and environmental friendliness of sulfur. However, the large-scale application/deployment of Li—S batteries is still impeded by multiple challenges. First, the insulating nature of sulfur and its discharge products, Li₂S₂/Li₂S, gives rise to a limited utilization of the active material. High-order lithium polysulfides (Li₂Sx, 4≤x≤8), present as intermediate products during cycling, have a high solubility in the liquid electrolyte, so that they can shuttle between the two electrodes, reacting at both sides, and inevitably leading to fast capacity fade and decreased coulombic efficiency. Once the soluble and highly polar lithium polysulfides (LiPSs) are formed, they can lose electrical contact with the conductive matrix, due to their poor affinity, increasing the charge transfer resistance and slowing the kinetics of the polysulfides redox reactions. In addition, the large volumetric change (80%) of sulfur during discharge can also affect the integrity of the electrodes. Carbonaceous materials with various morphologies, as sulfur hosts, have been reported to improve the electronic conductivity of the sulfur electrode and mitigate the diffusion of LiPSs. However, when considering long-term cycling and rate performance, it is difficult for a carbon host, by itself, to meet the above-mentioned requirements. It is likely that since carbon is nonpolar in nature, it cannot provide efficient trapping of highly-polar and ionic polysulfides.

Recently, polar materials, including metal oxides and metal sulfides, have been investigated as sulfur hosts and employed in composites with sulfur in Li—S cells. However, most of these polar hosts are non-conducting materials and thus cannot transport electrons effectively. In addition, the limited surface area of these hosts cannot provide sufficient contact area for chemical interactions with LiPSs, or physically entrap lithium sulfides within the hosts. In the synthesis of sulfur containing composites, melt-diffusion is a popular and routine method to infuse sulfur into the pores of the hosts. However, the sulfur species formed by melt diffusion are often in the form of a continuous film, which leads to the preferential deposition of Li₂S on it. This forms a passivating layer that blocks charge transfer, severely affecting capacity, cycle life and rate performance. Fabricating sulfur composites by in situ encapsulating sulfur within a conductive framework that combines both physical entrapment and chemical interactions, can serve as a promising method to synergistically enhance utilization of the active material and mitigate shuttling issues.

Metal-organic-framework (MOF) materials have been studied as sulfur host materials, due to their facile and cost-effective synthesis, high surface area and tunable porosity. In addition, both the open metal centers and heteroatomic dopant sites can show strong adsorption ability towards lithium polysulfides. Zeolitic imidazolate framework-67 (ZIF-67), which is composed of metal ions (Co²⁺) and an organic compound (2-methylimidazole) is a popular type of MOF. Most previous work utilizing MOF in Li—S cells is based on melt diffusing sulfur into the pores of the MOF materials or initially carbonizing the MOF and subsequently infusing sulfur into the pores via melt diffusion. It should be noted that ZIFs in themselves are not conducting due to the existence of organic linkers, so that compositing (insulating) sulfur with a non-conductive ZIF will slow down the charge transfer kinetics of adsorbed polysulfides, leading to a low utilization of active material as well as poor cycling performance.

### SUMMARY OF THE DISCLOSURE

In an aspect, the present disclosure provides MOF-sulfur compositions. A MOF-sulfur composition may be a MOF (e.g., a ZIF) comprising a plurality of sulfur nanoparticles encapsulated in the MOF or a plurality such MOFs. A MOF-sulfur composition may be made by a method of the present disclosure.

A MOF comprises a plurality of metal ions. The metal ions are connected (by one or more chemical bonds) to organic ligands (which may be referred to as organic groups), which are multidentate (e.g., bidentate) forming one-, two-, or three-dimensional structures.

A MOF comprises an organic group or a plurality of organic groups. An organic group (e.g., an organic ligand or an organic group derived from an organic ligand) comprises one or more functionality(ies). An organic group is coordinated to one or more metal ion(s).

A MOF may comprise sulfur nanoparticles. In various examples, a MOF comprises sulfur nanoparticles having a size of 300 to 800 nm, including all 0.1 nm values and ranges therebetween, and/or the sulfur nanoparticles are present at least at 70%, at least at 75%, at least at 80%, at least at 85%, or at least at 90% by weight (based on the total weight of the MOF and sulfur nanoparticles).

In an aspect, the present disclosure describes compositions. A composition may comprise a plurality of MOFs of the present disclosure. A composition can have various MOFs.

In an aspect, the present disclosure provides methods of making MOF-sulfur compositions. A method may be used to make a MOF comprising sulfur. A method may be an in situ method. Non-limiting examples of methods are provided herein. In various examples, a MOF-sulfur composition is made by a method of the present disclosure. MOFs can be formed in situ in a method. A method of making a MOF or MOFs may comprise use of preformed MOFs.

In an aspect, the present disclosure describes composite compositions. A composite composition may be made from a MOF-sulfur composition of the present disclosure (e.g., using a method of the present disclosure) and/or a method of making composite compositions of the present disclosure. In various examples, a composite material comprises a plurality of domains, each domain comprising: a conducting carbon matrix, which may be a carbon shell; a plurality of sulfur domains disposed within (e.g., encapsulated within) the carbon matrix, which may be a carbon shell; and a plurality of metal sulfide domains (which may be crystalline) disposed within (e.g., encapsulated within) the carbon matrix, which may be a carbon shell, and, optionally, a plurality of sulfur domains not disposed within the conducting carbon matrix, which may be a carbon shell. In various examples, a composite material comprises a conducting carbon matrix; a plurality of sulfur domains disposed within (e.g., encapsulated within) the carbon matrix; and a plurality of metal sulfide domains (which may be crystalline) disposed within (e.g., encapsulated within) the carbon matrix, and, optionally, a plurality of sulfur domains not disposed within the conducting carbon matrix. The composite may be a plurality of particles.

In an aspect, the present disclosure provides methods of making composite compositions. The methods may use a MOF-sulfur composition of the present disclosure. In various examples, a method of making a composite material of the present disclosure comprises: thermally treating (e.g., partially carbonizing) a plurality of metal-organic frameworks (MOFs), where at least a portion or all of the MOFs comprise a plurality of sulfur nanoparticles encapsulated in the MOFs, where a composite material of the present disclosure is formed.

In an aspect, the present disclosure provides cathodes. The cathodes can be used in devices such as, for example, batteries, superconductors, and the like. The cathodes comprise one or more composite material (where each composite material may be the same or at least two one of the composite materials is different) of the present disclosure. Non-limiting examples of cathodes are provided herein.

A cathode may comprises one or more composite material(s) present disclosure and/or one or more composite material(s) made by a method of the present disclosure. A cathode may further comprise one or more carbon material(s) or one or more binder material(s), or both. A cathode may comprise various amounts of sulfur.

In an aspect, the present disclosure provides devices. The devices comprise one or more composite material of the present disclosure, which may be part of one or more cathode(s), and/or one or more composite material(s) formed by a method of the present disclosure, which may be part of one or more cathode. A device may be a battery (e.g., a rechargeable/secondary battery, such as, for example, a lithium-ion conducting or sodium-ion conducting rechargeable/secondary battery), which may be a lithium-sulfur battery or a sodium-sulfur battery. A battery may further comprise one or more additional component(s) typically found in a battery.

### BRIEF DESCRIPTION OF THE FIGURES

For a fuller understanding of the nature and objects of the disclosure, reference should be made to the following detailed description taken in conjunction with the accompanying figures.

FIG. 1 shows a schematic illustration of the synthesis procedures of S/ZIF-67, S/Z-CoS₂ and S/H-CoS₂.

FIG. 2 shows (a) powder XRD patterns of sulfur/ZIF-67 composite (S/ZIF-67) and sulfur/ZIF-67-derived CoS₂ in a carbon framework (S/Z-CoS₂) and standard XRD patterns of CoS₂, ZIF-67 and elemental S₈. (b) EXAFS spectra of S/ZIF-67 and S/Z-CoS₂ with k²-weighting and no phase correction. EXAFS fitting results and XANES spectra can be found in FIGS. 10-11. (c) Cryogenic Bright-field (BF) TEM images of S/Z-CoS₂ showing the projected hexagonal symmetry and the rough surface at T=−183° C. (d) Atomic-scale BF-TEM image of a CoS₂ nanoparticle.

FIG. 3 shows cryogenic electron microscopy (Cryo-EM) imaging and EDX elemental mapping. (a) Cryo-SEM image of S/ZIF-67 composite at T=−165° C. (b) Cryo-STEM image of S/ZIF-67 at T=−183° C. (c-e) STEM-EDX elemental maps of Co (red), S (green) and color overlay (yellow) of Co and S, corresponding to the particle in (b). (f) Cryo-SEM image of S/Z-CoS₂. (g) Cryo-STEM image of S/Z-CoS₂. (h-j) Cryo-STEM-EDX elemental maps of Co (red), S (green) and color overlay (yellow) of Co and S, corresponding to the particle in (g). EDX spectrum corresponding to the particle in (g) can be found in FIG. 15. More examples of EDX maps of S/ZIF-67 and S/Z-CoS₂ can be found in FIGS. 13 and 14, respectively.

FIG. 4 shows (a) HAADF-STEM image of hollow ZIF-67 micrometer-sized particles. (b) STEM image of a specific hollow ZIF-67 particle. Lower image contrast in the middle of the particles clearly suggests a hollow structure. (c) Cryo-STEM image of S/H-CoS₂ composite particles. (e-f) Cryo-STEM-EDX elemental maps of Co (red), S (yellow) and color overlay of Co and S. Yellow suggests an overlay of Co and S elements while green indicates pure elemental sulfur. EDX spectrum of the composite particle in the dashed box can be found in FIG. 16. More examples of EDX maps of S/H-CoS₂ can be found in FIG. 17.

FIG. 5 shows (a) photographs of Li₂S₆ solution and Li₂S₆ solutions after adding Z-CoS₂, commercial CoS₂ and ZIF-67 powders. (b) UV/Vis absorption spectra of lithium polysulfide (Li₂S₆) solution before and after adding Z-CoS₂, commercial CoS₂ and ZIF-67.

FIG. 6 shows CV profiles of (a) S/Z-CoS₂, (b) S/H-CoS₂, and (c) S/ZIF-67 for 10 cycles at a scan rate of 0.1 mV s⁻¹. (d) Cycling performance of S/Z-CoS₂, S/H-CoS₂, and S/ZIF-67 at 0.2 C for 200 cycles. (e) Long-term cycling of S/Z-CoS₂, S/H-CoS₂, and S/ZIF-67 at 1 C for 1000 cycles.

FIG. 7 shows (a) rate performance of S/Z-CoS₂, S/H-CoS₂, and S/ZIF-67 at C rates from 0.1 C to 5.0 C. (b) Rate performance of high sulfur loading electrodes of S/Z-CoS₂. (c) Cycling performance of S/Z-CoS₂ with high sulfur loading at 0.2 C rate.

FIG. 8 shows CV profiles of (a) S/Z-CoS₂, (b) S/H-CoS₂, and (c) S/ZIF-67 at various scan rates from 0.1 mV s⁻¹ to 0.5 mV s⁻¹. Plots of S/Z-CoS₂, S/H-CoS₂, and S/ZIF-67 peak current vs square root of scan rates for (d) cathodic peak 1, (e) cathodic peak 2, and (f) anodic peak 1.

FIG. 9 shows a photograph of samples S/ZIF-67, S/Z-CoS₂, hollow ZIF-67, S/H-CoS₂ and ZIF-67. Purple S/ZIF-67 was transformed to the black S/Z-CoS₂ composite via the heat treatment. After the solid ZIF-67 was treated by tannic acid, dark purple hollow ZIF-67 was obtained. The sample turned to black when the hollow ZIF-67 was mixed with sulfur and went through the heat treatment.

FIG. 10 shows EXAFS profiles and fitting results for (a) S/ZIF-67 and (b) S/Z-CoS₂ composites. The fitting was performed within a Welch window between 1 and 5.5 Å. ZIF-67 and CoS₂ standard references were used to fit the experimental data. The R-factors of fittings results are 0.027 for S/ZIF-67 and 0.013 for S/Z-CoS₂. An R factor less than 0.05 usually indicates a good quality of fit.

FIG. 11 shows XANES spectra of Co K-edge of S/ZIF-67 and S/ZIF-67 derived CoS₂ (S/Z-CoS₂) composites. The XANES spectrum of S/Z-CoS₂ exhibits similar features as for S/ZIF-67. The shift to lower energies of S/Z-CoS₂, relative to that of S/ZIF-67, suggests a decrease in Co oxidation state during the heating treatment.

FIG. 12 shows (a) Raman spectra of S/Z-CoS₂ and S/ZIF-67. (b) TGA curves of S/Z-CoS₂, S/ZIF-67, and S/H-CoS₂ at a ramp rate of 10° C. min⁻¹ in Ar.

FIG. 13 shows cryo-STEM images of S/ZIF-67 composite particles and the corresponding maps of Co (red), S (green) and color overlay (yellow) of Co and S.

FIG. 14 shows (a-b) cryo-STEM images of S/ZIF-67-derived CoS₂ at its initial state and after EDX mapping, respectively, suggesting no noticeable beam damage during EDX mapping. EDX maps were acquired for 10 min to achieve more than 100 counts/pixel for sulfur and more than 50 counts/pixel for cobalt, with a beam voltage of 200 keV, a beam dose of 6-7 e/(nm²·s) and a pixel size of 128×128. Beam damage of all other STEM-EDX maps has been routinely examined before and after EDX mapping.

FIG. 15 shows cryo-STEM images of S/ZIF-67-derived CoS₂ (S/Z-CoS₂) composite particles and the corresponding EDX elemental maps of Co (red), S (green) and color overlay (yellow) of Co and S.

FIG. 16 shows EDX spectrum of S/ZIF-67-derived CoS₂ composite, corresponding to the particle in FIG. 3g. S/Co atomic ratio was quantified to be 6.7:1 based on S and Co K-edges, which is quite consistent with the S/Co ratio (about 8:1) calculated from TGA results. This suggests that the majority of the sulfur is confined within the cage of ZIF-67-derived CoS₂ rather than remaining external to the particles.

FIG. 17 shows EDX spectrum of hollow ZIF-derived CoS₂ (H-CoS₂) composite, corresponding to the particle in FIG. 3b. S/Co atomic ratio was quantified to be around 9.5:1 based on S and Co K-edges, which is significantly larger than the S/Co ratio (2:1) in CoS₂, suggesting the existence of elemental sulfur in the cage of H-CoS₂.

FIG. 18 shows Cryo-STEM images of S/hollow ZIF-derived CoS₂ (S/H-CoS₂) composite particles and the corresponding EDX elemental maps of Co (red), S (green) and color overlay (yellow) of Co and S. Yellow suggests an overlay of Co and S elements while green indicates pure elemental sulfur.

FIG. 19 shows EIS spectra of S/Z-CoS₂, S/H-CoS₂, and S/ZIF-67.

FIG. 20 shows cycling performance of S/Z-CoS₂, S/H-CoS₂, and S/ZIF-67 at 0.2 C for 200 cycles. (The capacity values were calculated based on the mass of the composite).

FIG. 21 shows charge/discharge profiles of S/Z-CoS₂ at high loading at various C-rates.

FIG. 22 shows (a) GITT profiles of S/Z-CoS₂ and calculated lithium ion diffusion coefficients. (b) Comparison of lithium ion diffusion coefficients of S/Z-CoS₂, S/H-CoS₂, and S/ZIF-67.

FIG. 23 shows SEM images of S/Z-CoS₂ electrodes (a,b) before cycling, and (c,d) after 20 cycles.

FIG. 24 shows (upper left) a cryo-STEM-EDX elemental map. (Upper middle) a micrograph of a S/ZIF-derived-CoS₂ composite. (Upper right) EXAFS spectra of S/ZIF-67 and S/Z-CoS₂ with k²-weighting and no phase correction. (Bottom) Long-term cycling of S/Z-CoS₂, S/H-CoS₂, and S/ZIF-67 at 1 C for 1000 cycles.

### DETAILED DESCRIPTION OF THE DISCLOSURE

Although subject matter of the present disclosure is described in terms of certain embodiments and examples, other embodiments and examples, including embodiments and examples that do not provide all of the benefits and features set forth herein, are also within the scope of this disclosure. For example, various structural, logical, and process step changes may be made without departing from the scope of the disclosure.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent and multivalent, such as, for example, divalent, trivalent, and the like, radicals). Illustrative examples of groups include:

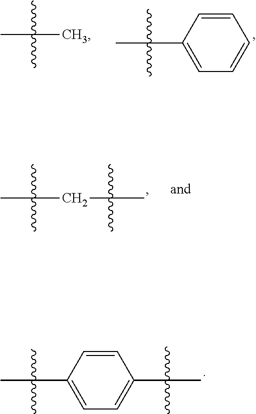

The present disclosure provides metal organic fragment (MOF)-sulfur compositions. The present disclosure also provides methods of making the compositions and composite materials, and uses thereof.

In an aspect, the present disclosure provides MOF-sulfur compositions. Non-limiting examples of MOF-sulfur compositions are provided herein. A MOF-sulfur composition may be a MOF (e.g., a ZIF) comprising a plurality of sulfur nanoparticles encapsulated in the MOF or a plurality such MOFs. A MOF-sulfur composition may be made by a method of the present disclosure.

A MOF comprises a plurality of metal ions. The metal ions are connected (by one or more chemical bonds) to organic ligands (which may be referred to as organic groups), which are multidentate (e.g., bidentate) forming one-, two-, or three-dimensional structures. The metal ions may be transition metal ions (e.g., ions of first row transition metals such as, for example, Fe, Co, Cu, Zn, and the like, and combinations thereof), post-transition metal ions, metalloids, alkaline earth metal ions, alkali metal ions, lanthanides, actinides, or a combination thereof. For example, the metal ligand ions are transition metal ions (e.g., ions of first row transition metals such as, for example, Fe, Co, Cu, Zn, and the like, and combinations thereof) connected by organic ligands, which are multidentate (e.g., bidentate) forming one-, two-, or three-dimensional structures. The oxidation state of individual metal ions may be ⁺1, ⁺2, ⁺3, or ⁺4. The MOFs may be porous.

A MOF comprises an organic group or a plurality of organic groups. An organic group (e.g., an organic ligand or an organic group derived from an organic ligand) comprises one or more functionality(ies). An organic group is coordinated to one or more metal ion(s). Non-limiting examples include nitrogen-containing functionalities (e.g., nitrogen donors such as, for example, substituted or unsubstituted pyridine, pyridyls, imidazoles/imidazolates (e.g., 2-methylimidazole group, and the like), tetrazoles/tetrazolates, triazoles/triazolates, pyrazoles/pyrazolates, pyrazines, pyrimidines, and the like and other N-heterocyclic ring structures), oxygen-containing functionalities (e.g., oxygen donors such as, for example, substituted or unsubstituted carboxylic acids/carboxylates (e.g., triethyl-1,3,5-benzenetricarboxylic acid/triethyl-1,3,5-benzenetricarboxylate, benzene-1,3,5-tricarboxylic acid/benzene-1,3,5-tricarboxylate, 1,4-benzene dicarboxylic acid/1,4-benzene dicarboxylate, 2,5-dihydroxybenzene-1,4-dicarboxylic acid/2,5-dihydroxybenzene-1,4-dicarboxylate, fumaric acid/fumarate, 4 4′-biphenyldicarboxylic acid/4 4′-biphenyldicarboxylate, ketones, —OH, —O⁻, phosphonic acids/phosphonates, sulfonic acids/sulfonates, and the like), sulfur containing functionalities (e.g., thiol groups and the like), and groups formed therefrom (e.g., a deprotonated version thereof and the like), and combinations thereof. In various examples, a MOF comprises an organic group comprising one or more functionality chosen from nitrogen-containing functionality, oxygen-containing functionality, ketones, —OH, —O⁻, phosphonic acids/phosphonates, sulfonic acids/sulfonates, and sulfur containing functionality.

Various organic ligands can be used. An organic ligand may have a single type of functionality (e.g., metal ion coordinating functionality) or may be a multi-functional ligand (e.g., one or more metal ion coordinating functionality, which may the same or different types of metal ion coordinating functionality, and/or one or more non-coordinating functionality, which may the same or different types of non-coordinating functionality). An organic ligand may have 2-12 (e.g., 2, 3, 4, 5, 6, 7, 8, 9, 10, 11, or 12) or more coordination sites. An organic ligand may have one or more non-metal ion coordinating functional groups. In the case of ZIFs, non-limiting examples of organic ligands include imidazoles (for example, which may functionalized in any or all of the positions of the imidazoles, such as, for example, the 2,4,5 positions of an imidazole) and benzimidazoles (can may be functionalized, e.g. 5-chlorobenzimidazole, 5-bromobenzimidazole, and the like). Other MOFs may have ligands comprising coordinating pyrazolates, tetrazolates, pyridinyl, carboxylates, thiols, and the like, and combinations thereof. The core of an organic ligand may be aliphatic, aromatic, heterocyclic, or the like. An organic ligand may comprise 1-10 (e.g., 1, 2, 3, 4, 5, 6, 7, 8, 9, or 10) or more ring structures (which may comprise one or more heteroatoms). The one or more ring structures may comprise two or more fused ring structures and/or one or more biaryl groups. Other non-limiting illustrative examples of organic ligands include dicarboxylates (e.g., 1,4-benzene dicarboxylate), tricarboxylates (e.g., 1,3,5-benzenetricarboxylate, and 1,3,5-benzenetribenzoate), polycarboxylates, and the like. Other non-limiting illustrative examples of organic ligands include organic ligands with two or more nitrogen donors or two or more oxygen donors, or two or more sulfur donors or at least two donors chosen from nitrogen donors, oxygen donors, or sulfur donors. Various examples of MOFs are known in the art.

A MOF may comprise copper ions (e.g., HKUST-1 (which comprises copper ions). A MOF or MOFs may be M-MOF-74 (which comprises magnesium ions, cobalt ions, nickel ions, or manganese ions) or MOF-5. A MOF or MOFs may be a MIL(s) (e.g., MIL-101 (which comprises chromium ions), MIL-53 (which comprises aluminum ions), MIL-88 (which comprises iron ions), MIL-101 (which comprises aluminum ions), MIL-101 (which comprises iron ions), MIL-100 (which comprises vanadium ions), MIL-125 (which comprises titanium ions). MOF may be a ZIF (a zeolitic imidazolate framework). A ZIFs may comprise a plurality of tetrahedrally-coordinated transition metal ions (e.g., first row transition metal ions such as, for example, Fe ions, Co ions, Cu ions, Zn ions, and the like, and combinations thereof) connected by imidazolate linkers. A MOF or ZIFs may comprise both Zn and Co ions (e.g., ZIF-67 and the like). ZIFs may comprise Zn ions (e.g., ZIF-8 and the like). For example, the MOF is a Zn/Co ZIF (a ZIF comprising both Zn and Co) with a Zn/Co molar ratio ranging from 1:9 to 9:1, including all integer molar ratio values and ranges therebetween. Various examples of ZIFs are known in the art and non-limiting examples of ZIFs are provided herein. A composition comprising a plurality of MOFs may comprise one or any combination of these MOFs.

A MOF can have various morphologies. In various examples, a MOF or the MOFs individually have cubic, dodecahedral, spindle, octahedral, spherical, acicular, bladed, botryoidal, columnar, coxcomb, dendritic, enantiomorphic, equant, fibrous, hemimorphic, hexagonal, octahedral, platy, prismatic, pseudo-hexagonal, pyramidal, colloform, reticulated, lenticular, sphenoid, stellate, tetrahedral, wheat sheaf, tubular, or monolithic morphology.

A MOF may have various sizes. In various examples, a MOF has a size (e.g., longest dimension or at least one dimension) of 0.1 micron to 10 microns (e.g., 0.5 micron to 10 microns or 1 to 2 microns), including all 0.01 micron values and ranges therebetween. In various examples, the MOF has a size (e.g., longest dimension or at least one dimension) of 0.3-10 microns, including all 0.01 micron values and ranges therebetween.

A MOF can comprise various amounts and forms of sulfur. A MOF may comprise sulfur nanoparticles, at least a portion of which may be disposed inside the MOF. A MOF may comprise sulfur (at least a portion or all of which may be sulfur particles) disposed on at least a portion of one or more or all of the surface(s) of the MOF. In various examples, the sulfur nanoparticles have a size (e.g., a longest dimension) of 300 to 800 nm, including all integer nm values and ranges therebetween. The sulfur nanoparticles may have a spherical (or substantially spherical) shape. In various examples, the sulfur nanoparticles are present at least at 70%, at least at 75%, at least at 80%, at least at 85%, or at least at 90% by weight (based on the total weight of the MOF and sulfur nanoparticles). In various examples, a MOF comprises sulfur nanoparticles having a size (e.g., a longest linear dimension) of 300 to 800 nm, including all 0.1 nm values and ranges therebetween, and the sulfur nanoparticles are present at least at 70%, at least at 75%, at least at 80%, at least at 85%, or at least at 90% by weight (based on the total weight of the MOF and sulfur nanoparticles).

In an aspect, the present disclosure describes compositions. A composition may comprise a plurality of MOFs of the present disclosure. Non-limiting examples of compositions are provided herein.

A composition can comprise various MOFs. The MOFs of a composition may have the same nominal structure. The MOFs of a composition may be such that at least 2 of the MOFs have different nominal structure.

In an aspect, the present disclosure provides methods of making MOF-sulfur compositions. A method may be used to make a MOF comprising sulfur. A method may be an in situ method. Non-limiting examples of methods are provided herein. In various examples, a MOF-sulfur composition is made by a method of the present disclosure.

Various metal precursors can be used. A combination of metal precursors may be used. A metal precursor may be a metal salt or a metal oxide, or a combination thereof. In various examples, the metal precursor(s) is/are a metal salt/salts chosen from metal nitrate salts, metal acetate salts, metal formate salts, metal tetrafluoroborate salts, metal halide salts, metal oxychloride salts, metal sulfate salts, metal perchlorate salts, metal carbonate salts, metal oxalate salts, metal silicofluoride salts, metal acetylacetonate salts, metal benzoate salts, and metal formate salts, and combinations thereof, or metal oxides, or a combinations thereof.

Various organic ligands can be used. A combination of organic ligands may be used. Non-limiting examples of organic ligands are described above with regard to the description of MOFs. In various examples, the organic ligand is chosen from nitrogen-containing ligands (e.g., nitrogen donor ligands such as, for example, substituted or unsubstituted pyridines, pyridyls, imidazoles (e.g., 2-methylimidazole, and the like), tetrazoles, triazoles, pyrazoles, pyrazines, pyrimidines, and the like, and other ligands comprising N-heterocyclic ring structures), oxygen-containing ligands (e.g., oxygen donor ligands such as, for example, substituted or unsubstituted carboxylic acids, ketones, ligands comprising one or more —OH, ligands comprising one or more —O⁻, phosphonic acids, sulfonic acids, and the like), or sulfur containing ligands (e.g., thiols). Deprotonated analogs of any of these ligands may be used.

MOFs can be formed in situ in a method. A method of making a MOF or MOFs may comprise in situ formation of MOFs. The MOFs may be formed on one or more nanoparticle(s). In various examples, a method of making a MOF (e.g., S/Z-CoS₂) or MOFs of the present disclosure or a composition of the present disclosure comprises: forming a reaction mixture comprising: sulfur nanoparticles (which may be added as a dispersion in an alcohol/polymer mixture or water), a metal precursor (e.g., a metal salt) (e.g., where the metal ion is a first row transition metal ion), and an organic ligand (which forms an organic group); and holding the reaction mixture for a selected time, and, optionally, at a selected temperature, where the MOF/MOFs or composition (either of which may be a plurality of particles) is formed. In an example, the method steps are carried out in the order provided. In various illustrative examples, the reaction mixture is held for 16 to 30 hours, including all 0.1 hour values and ranges therebetween, and/or at a temperature of 18° C. to 28° C. (e.g., room temperature). The reactant ratio can be used to control the size of the MOFs. For example, a metal ion to organic compound ratio range of 1:2 to 1:5 is used. After combining (e.g., mixing the reactants, the reaction mixture may be aged (e.g., held for a selected time, and, optionally, at a selected temperature) without active mixing (e.g., stirring). Without intending to be bound by any particular theory, it is considered that aging without active mixing can provide MOFs (which may be MOF particles) having a uniform morphology.

A method of making a MOF or MOFs of the present disclosure may comprise use of preformed MOFs. In various examples, a method of making a MOF or MOFs comprising sulfur encapsulated in the individual MOF(s) (e.g., S/H-CoS₂) or a composition comprising a plurality of MOFs comprising sulfur encapsulated in the individual MOFs comprises: providing a MOF or a composition comprising a plurality of MOFs, which may be the same MOFs or at least two different MOFs); contacting the MOF or the composition comprising a plurality of MOFs with an acid (e.g., tannic acid, gallic acid, and the like) to form MOFs with hollow structure; contacting the MOF(s) with sulfur to form a mixture, which may be referred to as a reaction mixture; and heating the mixture (e.g., under vacuum at 300° C. for 7 hours), where the MOF comprising sulfur encapsulated in the MOF or a composition comprising a plurality of MOFs comprising sulfur encapsulated in the individual MOFs is formed. The MOFs may further comprise sulfur (at least a portion or all of which may be sulfur particles) disposed on at least a portion of one or more or all of the surface(s) of the MOFs.

In an aspect, the present disclosure describes composite compositions. A composite composition may be made from a MOF-sulfur composition of the present disclosure (e.g., using a method of the present disclosure) and/or a method of making composite compositions of the present disclosure. Non-limiting examples of composite compositions are provided herein.

In various examples, a composite material comprises a plurality of domains, each domain comprising: a conducting carbon matrix, which may be a carbon shell, (e.g., the carbon matrix, which may be a carbon shell, has the same shape or substantially same shape as the MOF(s) from which the composite is formed (e.g., one or more or each dimension of the carbon shell is +/−5%, 1%, or 0.1% of the MOF from which the composite is formed)); optionally, a plurality of sulfur domains (which may be crystalline) disposed within (e.g., encapsulated within) the carbon matrix, which may be a carbon shell; and a plurality of metal sulfide domains (which may be crystalline) disposed within (e.g., encapsulated within) the carbon matrix, which may be a carbon shell, and, optionally, a plurality of sulfur domains not disposed within the conducting carbon matrix, which may be a conducting carbon shell. For example, at least 90% or all of the metal sulfide domains have a size (e.g., a longest dimension) of 10-30 nm (e.g., 20-25 nm). In various examples, at least 90% or all of the metal sulfide domains have a size (e.g., a longest dimension, which may be a linear dimension) of 10, 11, 12, 13, 14, 15, 16, 17, 18, 19, 20, 21, 22, 23, 24, 25, 26, 27, 28, 29, 30 nm, or a range with bounds chosen therefrom. The composite may be a plurality of particles.

A carbon matrix, which may be a carbon shell, may comprise (or is) one or more various form(s) of carbon. Non-limiting examples of carbon forms include graphitic carbon, non-graphitic carbon, and the like, and combinations thereof. The carbon can have various morphologies. In various examples, the carbon matrix, which may be a carbon shell, has a spindle, cubic, dodecahedral, octahedral, spherical, acicular, bladed, botryoidal, columnar, coxcomb, dendritic, enantiomorphic, equant, fibrous, hemimorphic, hexagonal, octahedral, platy, prismatic, pseudo-hexagonal, pyramidal, colloform, reticulated, lenticular, sphenoid, stellate, tetrahedral, wheat sheaf, tubular, or monolithic morphology. For example, the carbon matrix, which may be a carbon shell, formed has the same morphology as the MOF from which it is formed.

A carbon matrix, which may be a carbon shell, can have various sizes. In various examples, the carbon matrix, which may be a carbon shell, has a size (e.g., longest dimension or at least one dimension) of 0.1 micron to 10 microns (e.g., 0.5 micron to 10 microns or 1 to 2 microns).

Sulfur (which may be present as sulfur domains, some or all of which may be sulfur nanoparticles, one or more metal sulfide(s), or a combination thereof) can be present in the composite in various amounts. In various examples, the sulfur (e.g., sulfur domains, some or all of which may be sulfur nanoparticles, one or more metal sulfide(s), or a combination thereof) is present at least at 55%, at least at 59%, at least at 65%, at least at 70%, at least at 75%, at least at 80%, at least at 85%, or at least at 90% by weight (based on the total weight of the composite material). At least a portion of or all of the sulfur (e.g., the sulfur, some or all of which may be sulfur nanoparticles, and/or metal sulfide domains may be in electrical contact with each other.

In an aspect, the present disclosure provides methods of making composite compositions. The methods may use a MOF-sulfur composition of the present disclosure. Non-limiting examples of methods are provided herein.

In various examples, a method of making a composite material of the present disclosure comprises: thermally treating (e.g., partially carbonizing) a plurality of (or a composition comprising) metal-organic frameworks (MOFs) (e.g., ZIFs), where at least a portion or all of the MOFs comprise a plurality of sulfur nanoparticles encapsulated in the MOFs (e.g., a composition of the present disclosure), where a composite material of the present disclosure is formed.

It may be desirable to carry out the thermal treatment in a sealed container (e.g., no gas flow). It is desirable to avoid the loss of sulfur via sublimation. The thermal treatment can be carried out in inert atmosphere (e.g., N₂, Ar, and the like, and combinations thereof). The thermal treatment may result in partial carbonization (e.g., 70% or greater carbonization by weight) of the MOFs to form carbon materials (e.g., a combination of both graphitic carbon and disordered carbon). The sulfur or sulfur nanoparticles may be reacted with metal of the MOF(s) during the thermal treatment to form metal-sulfides. In an example, the thermal treatment comprises heating the composite at a temperature of 250 to 450° C., including all 0.1° C. values and ranges therebetween, or a time of 1 to 24 hours (e.g., 5 to 12 hours), including all 0.1 hour values and ranges therebetween, or both. The thermal treatment may be carried out at a sub-ambient pressure (e.g., vacuum) (e.g., a pressure of 4-7 μHg, including all 0.1 μHg values and ranges therebetween).

In an aspect, the present disclosure provides cathodes. The cathodes can be used in devices such as, for example, batteries, superconductors, and the like. The cathodes comprise one or more composite material (where each composite material may be the same or at least two one of the composite materials is different) of the present disclosure. Non-limiting examples of cathodes are provided herein.

A cathode may comprises one or more composite material(s) (e.g., one or more composite material(s) of the present disclosure and/or made by a method of the present disclosure.

A composite material or composite materials may have various thickness. In various examples, a cathode comprises a layer of composite material(s) having a thickness of 1-500 microns, including all 0.1 micron values and ranges therebetween.

A cathode may further comprise one or more carbon material(s) or one or more binder material(s), or both. Non-limiting examples of carbon materials include Super-P® carbon, carbon paper, and the like. The carbon material(s) may be conducting. Non-limiting examples of binder materials include polymer materials such as, for example, thermoplastic polymers, and the like. Polyvinylidene-fluoride (PVDF) is a non-limiting example of a suitable binder material. Examples of suitable additional materials for cathodes (e.g., carbon materials, binder materials, and the like) are known in the art.

A cathode may comprise various amounts of sulfur. In various examples, a cathode comprises sulfur at 50-85% by weight (based on the total weight of the cathode).

In an aspect, the present disclosure provides devices. The devices comprise one or more composite material of the present disclosure, which may be part of one or more cathode, and/or one or more composite material formed by a method of the present disclosure, which may be part of one or more cathode. Non-limiting examples of devices are provided herein.

A device may be a battery (e.g., a rechargeable/secondary battery, such as, for example, a lithium-ion conducting or sodium-ion conducting rechargeable/secondary battery), which may be a lithium-sulfur battery or a sodium-sulfur battery. Non-limiting examples of devices are provided herein.

A battery may further comprise one or more additional component(s) typically found in a battery. Non-limiting examples of additional components include anodes, electrolytes (such as, for example, solid electrolytes, liquid electrolytes, and the like). In various examples, a battery further comprise one or more anode(s), one or more electrolyte(s), one or more current collector(s), one or more additional structural component(s), or a combination thereof. Non-limiting examples of additional structural components include bipolar plates, external packaging, electrical contacts/leads to connect wires, and the like, and combinations thereof.

A battery may be a lithium-sulfur battery. A lithium-sulfur battery may comprise a plurality of cells, each cell comprising one or more cathode of the present disclosure, and optionally, one or more anode(s) or one or more cathode(s), one or more electrolyte(s), one or more current collector(s) or a combination thereof. A lithium-sulfur battery may comprise 1 to 500 cells, including all integer number of cells and ranges therebetween.

A device may exhibit one or more desirable properties. In various examples, a device exhibits one or more of the following: an areal capacity of at least 3 mAh/cm² and/or a stabilized capacity of at least 2.2 mAh/cm² after 150 cycles or more at 0.2 C (corresponding to a capacity retention of at least 73%) or a capacity of at least 1.5 mAh/cm² at a rate of 1 C, or both.

The steps of the method described in the various embodiments and examples disclosed herein are sufficient to produce a MOF-sulfur composition and/or a composite composition of the present disclosure. Thus, a method may consist essentially of a combination of the steps of the methods disclosed herein or a method may consist of such steps.

The following Statements describe examples of metal-organic framework-sulfur materials, composites, methods, and devices of the present disclosure:

Statement 1. A metal-organic framework (MOF) (e.g., a ZIF) comprising a plurality of sulfur nanoparticles encapsulated in the MOF.
Statement 2. The MOF according to Statement 1, where the sulfur nanoparticles have a size (e.g., a longest dimension) of 300 to 800 nm, including all integer nm values and ranges therebetween. The sulfur nanoparticles may have a spherical (or substantially spherical) shape. The sulfur nanoparticles may have a size (e.g., a longest dimension) of 300-800 nm (e.g., in various examples 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, 500, 505, 510, 515, 520, 525, 530, 535, 540, 545, 550, 555, 560, 565, 570, 575, 580, 585, 590, 595, 600, 605, 610, 615, 620, 625, 630, 635, 640, 645, 650, 655, 660, 665, 670, 675, 680, 685, 690, 695, 700, 705, 710, 715, 720, 725, 730, 735, 740, 745, 750, 755, 760, 765, 770, 775, 780, 785, 790, 795, 800 nm, or a range with bounds chosen therefrom).
Statement 3. The MOF according to Statement 1 or 2, where the MOF comprises a plurality of metal ions (e.g., transition metal ions, post-transition metal ions, metalloids, alkaline earth metal ions, alkali metal ions, lanthanides, actinides, or a combination thereof). For example, the metal ions are chosen from cobalt ions, zinc ions, iron ions, chromium ions, aluminum ions, vanadium ions, titanium ions, copper ions, and the like, and combinations thereof.
Statement 4. The MOF according to any one of the preceding Statements, where the MOF comprises an organic group (e.g., an organic ligand or an organic group derived from an organic ligand) comprising one or more functionality chosen from nitrogen-containing functionality (e.g., nitrogen donors such as, for example, substituted or unsubstituted pyridines, pyridyls, imidazoles/imidazolates (e.g., 2-methylimidazole group, and the like), tetrazoles/tetrazolates, triazoles/triazolates, pyrazoles/pyrazolates, pyrazines, pyrimidines, and the like and other N-heterocyclic ring structures), oxygen-containing functionality (e.g., oxygen donors such as, for example, substituted or unsubstituted carboxylic acids/carboxylates (e.g., triethyl-1,3,5-benzenetricarboxylic acid/triethyl-1,3,5-benzenetricarboxylate, benzene-1,3,5-tricarboxylic acid/benzene-1,3,5-tricarboxylate, 1,4-benzene dicarboxylic acid/1,4-benzene dicarboxylate, 2,5-dihydroxybenzene-1,4-dicarboxylic acid/2,5-dihydroxybenzene-1,4-dicarboxylate, fumaric acid/fumarate, 4 4′-biphenyldicarboxylic acid/4 4′-biphenyldicarboxylate), ketones, —OH, —O⁻, phosphonic acids/phosphonates, sulfonic acids/sulfonates, and the like), or sulfur containing functionality (e.g., thiol groups).
Statement 5. The MOF according to any one of the preceding Statements, where the MOF is chosen from MOFs comprising copper ions (e.g., HKUST-1 (which comprises copper ions), MILs (e.g., MIL-101 (which comprises chromium ions), MIL-53 (which comprises ion ions), MIL-88 (which comprises iron ions), MIL-101 (which comprises aluminum ions), MIL-101 (which comprises iron ions), MIL-100 (which comprises vanadium ions), MIL-125 (which comprises titanium ions), M-MOF-74 (which comprises magnesium ions, cobalt ions, nickel ions, or manganese ions), and the like), and MOF-5 or is a ZIF and is chosen from ZIFs comprising both Zn and Co ions (e.g., ZIF-67), ZIFs comprising Zn ions (e.g., ZIF-8), and the like, and combinations thereof. For example, the MOF is a Zn/Co ZIF (a ZIF containing both Zn and Co) with a Zn/Co molar ratio ranging from 1:9 to 9:1, including all integer molar ration values therebetween.
Statement 6. The MOF according to any one of the preceding Statements, where the sulfur nanoparticles are present at least at 70%, at least at 75%, at least at 80%, at least at 85%, or at least at 90% by weight (based on the total weight of the MOF and sulfur nanoparticles).
Statement 7. The MOF according to any one of the preceding Statements, where the MOF has a cubic, dodecahedral, spindle, octahedral, spherical, acicular, bladed, botryoidal, columnar, coxcomb, dendritic, enantiomorphic, equant, fibrous, hemimorphic, hexagonal, octahedral, platy, prismatic, pseudo-hexagonal, pyramidal, colloform, reticulated, lenticular, sphenoid, stellate, tetrahedral, wheat sheaf, tubular, or monolithic morphology.
Statement 8. The MOF according to any one of the preceding Statements, where the MOF has a size (e.g., longest dimension or at least one dimension) of 0.1 micron to 10 microns (e.g., 0.5 micron to 10 microns or 1 to 2 microns). In various examples, the MOF has a size (e.g., longest dimension or at least one dimension) of 0.3-10 microns (e.g., 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10 microns, or a range with bounds chosen therefrom).
Statement 9. A composition comprising a plurality of MOFs according to any one of Statements 1-8.
Statement 10. The composition according to Statement 9, where the MOFs have the same nominal structure.
Statement 11. The composition according to Statement 9, where at least 2 (e.g., at least 3, at least 4, or at least 5) of the MOFs have different nominal structure.
Statement 12. A method of making a MOF comprising sulfur nanoparticles of the present disclosure (e.g., S/ZIF-67 and the like) (e.g., according to any one of Statements 1-8 or a composition according to any one of Statements 9-11) comprising: forming a reaction mixture comprising: sulfur nanoparticles (which may be added as a dispersion in an alcohol/polymer mixture or water), a metal precursor (e.g., a metal salt) (e.g., where the metal ion of the metal salt is a transition metal, such as for example, a first row transition metal ion), and an organic ligand (which forms an organic group); and holding the reaction mixture for a selected time, and, optionally, at a selected temperature, where the MOF or composition (either of which may be a plurality of MOF particles) is formed. In an example, the method steps are carried out in the order provided. In illustrative examples, the reaction mixture is held for 16 to 30 hours and/or at a temperature of 18° C. to 28° C. (e.g., room temperature). The reactant ratio can be used to control the size of the MOFs. For example, a metal ion to organic compound ratio range of 1:2 to 1:5 is used. After combining (e.g., mixing) the reactants, the reaction mixture may be aged (e.g., held for a selected time, and, optionally, at a selected temperature) without active mixing (e.g., stirring). The reaction mixture may be subjected to mixing processes, such as for example, high-speed mixing, sonication, and the like. Without intending to be bound by any particular theory, it is considered that aging without active mixing can provide MOFs (which may be MOF particles) particles having a uniform morphology. A MOF may have sulfur nanoparticles within the pores. When carbonized, the MOF (or a plurality of such MOFs may provide a carbonized monolith comprising one or more metal sulfide(s) and optionally, one or more sulfur domain(s), which may correspond in at least size to or be sulfur nanoparticles, that may be dispersed throughout the monolith.
Statement 13. The method according to Statement 12, where the metal precursor is a metal salt (e.g., one or more metal salt(s)) chosen from metal nitrate salts, which may be hydrates, (e.g., Co(NO₃)₂, Zn(NO₃)₂, Mn(NO₃)₂, Cr(NO₃)₃, Fe(NO₃)₃, Ni(NO₃)₂, which may be hydrates, and the like), metal acetate salts, metal formate salts, metal tetrafluoroborate salts, metal halide salts (metal chloride salts (e.g., VCl₃), metal bromide salts, metal iodide salts, or metal fluoride salts), metal oxychloride salts, metal sulfate salts, metal perchlorate salts, metal carbonate salts, metal oxalate salts, metal silicofluoride salts, metal acetylacetonate salts, metal benzoate salts, metal formate salts, and the like, and combinations thereof, or a metal oxide, or the like, or a combination thereof.
Statement 14. The method according to Statement 12 or 13, where the organic ligand is chosen from nitrogen-containing ligands (e.g., nitrogen donor ligands such as, for example, substituted or unsubstituted pyridyls, imidazoles (e.g., 2-methylimidazole, and the like), tetrazoles, triazoles, pyrazoles, pyrazines, pyrimidines, and the like, and other ligands comprising N-heterocyclic ring structures), oxygen-containing ligands (e.g., oxygen donor ligands such as, for example, substituted or unsubstituted carboxylic acids, ketones, ligands comprising one or more —OH, ligands comprising on or more —O⁻, phosphonic acids, sulfonic acids, and the like), or sulfur containing ligands (e.g., thiols). Deprotonated analogs thereof may be used.
Statement 15. A method of making a MOF comprising sulfur encapsulated in the MOF (e.g., S/H-CoS₂) or a composition comprising a plurality of MOFs comprising sulfur encapsulated in the MOFs, the method comprising: providing a MOF or a composition comprising a plurality of MOFs, which may be the same MOFs or at least two different MOFs); contacting the MOF or the composition comprising a plurality of MOFs with an acid (e.g., tannic acid, gallic acid, and the like) to form MOFs with hollow structure; contacting the MOF(s) with sulfur to form a mixture; and heating the mixture (e.g., under vacuum at 300° C. for 7 hours), where the MOF comprising sulfur encapsulated in the MOF or a composition comprising a plurality of MOFs comprising sulfur encapsulated in the MOFs is formed.
Statement 16. A composite material comprising i) a plurality of domains, each domain comprising: a conducting a carbon matrix, which may be a carbon shell, or ii) a carbon matrix (e.g., the carbon matrix, which may be a carbon shell, has the same shape or substantially same shape as the MOF(s) from which the composite is formed (e.g., one or more dimension(s) or each dimension of the carbon matrix, which may be a carbon shell, is +/−5%, 1%, or 0.1% of that of the MOF(s) from which the composite is formed)); optionally, a plurality of sulfur domains (which may be crystalline), which may correspond in at least size to sulfur nanoparticles of the MOF from which the composite is formed or be the sulfur nanoparticles, or a combination thereof, disposed within (e.g., encapsulated within) the carbon matrix, which may be a carbon shell; and a plurality of metal sulfide domains (which may be crystalline) disposed within (e.g., encapsulated within) the carbon matrix, which may be a carbon shell, and optionally, a plurality of sulfur domains not disposed within the conducting carbon matrix, which may be a carbon shell. For example, at least 90% or all of the metal sulfide domains have a size (e.g., a longest dimension) of 10-30 nm (e.g., 20-25 nm). In various examples, at least 90% or all of the metal sulfide domains have a size (e.g., a longest dimension) of 10, 11, 12, 13, 14, 15, 16, 17, 18, 19, 20, 21, 22, 23, 24, 25, 26, 27, 28, 29, 30 nm, or a range with bounds chosen therefrom. The composite may be a plurality of particles.
Statement 17. The composite material according to Statement 16, where the carbon matrix, which may be a carbon shell, comprises a mixture of graphitic carbon and non-graphitic carbon.
Statement 18. The composite material according to Statement 16 or 17, where the carbon matrix, which may be a carbon shell, has a spindle, cubic, dodecahedral, octahedral, spherical, acicular, bladed, botryoidal, columnar, coxcomb, dendritic, enantiomorphic, equant, fibrous, hemimorphic, hexagonal, octahedral, platy, prismatic, pseudo-hexagonal, pyramidal, colloform, reticulated, lenticular, sphenoid, stellate, tetrahedral, wheat sheaf, tubular, or monolithic morphology. For example, the carbon matrix, which may be a carbon shell, formed has the same morphology as the MOF from which it is formed.
Statement 19. The composite material according to any one of Statements 16-18, where the carbon matrix, which may be a carbon shell, has a size (e.g., longest dimension or at least one dimension) of 0.1 micron to 10 microns (e.g., 0.5 micron to 10 microns or 1 to 2 microns), including all 0.01 micron values and ranges therebetween. In various examples, the carbon matrix, which may be a carbon shell, has a size (e.g., longest dimension or at least one dimension) of 0.1-10 microns (e.g., 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10 microns, or a range with bounds chosen therefrom).
Statement 20. The composite material according to any one of Statements 16-19, where the sulfur domains and/or metal sulfide domains are in electrical contact with each other.
Statement 21. The composite material according to any one of Statements 16-20, where the sulfur domains, some or all of which may be sulfur nanoparticles, and/or metal sulfide domains are present at least at 55%, at least at 59%, at least at 65%, at least at 70%, at least at 75%, at least at 80%, at least at 85%, or at least at 90% by weight (based on the total weight of the composite material.
Statement 22. A method of making a composite material (e.g., a composite composition according to any one of Statements 16-21) comprising: thermally treating (e.g., partially carbonizing) a plurality of (or a composition comprising) metal-organic frameworks (MOFs) (e.g., ZIFs), where at least a portion or all of the MOFs comprise a plurality of sulfur nanoparticles encapsulated in the MOFs (e.g., composition according to any one of Statements 9-11), where a composite material according to Statement 16 is formed. It may be desirable to carry out the thermal treatment in a sealed container (e.g., no gas flow). It is desirable to avoid the loss of sulfur via sublimation. The thermal treatment may be carried out in inert atmosphere (e.g., N2, Ar, and the like, and combinations thereof). The thermal treatment may result in partial carbonization (e.g., 70% or greater carbonization by weight) of the MOFs to form carbon materials (e.g., a combination of both graphitic carbon and disordered carbon). The sulfur or sulfur nanoparticles may be reacted with metal of the MOF(s) during the thermal treatment to form metal-sulfides.
Statement 23. The method according to Statement 22, where the thermal treatment comprises heating the composite at a temperature of 250 to 450° C. and/or a time of 1 to 24 hours (e.g., 5 to 12 hours).
Statement 24. The method according to Statement 22 or 23, where the thermal treatment is carried out at a sub-ambient pressure (e.g., vacuum) (e.g., a pressure of 4-7 μHg).
Statement 25. A cathode comprising a composite material (e.g., a composite material according to any one of Statements 16-21 or made by a method according to any one of Statements 22-24). E.g., where the cathode comprises a layer of the composite material (e.g., having a thickness of 1-500 microns).
Statement 26. The cathode according to Statement 25, where the cathode further comprises carbon material(s) (e.g., SuperP® carbon, carbon paper, and the like) and/or various binder material(s) (e.g., polymer materials such as, for example, thermoplastic polymers). The carbon material(s) may be conducting. Polyvinylidene-fluoride (PVDF) is a non-limiting example of a suitable binder material. Examples of suitable additional materials for cathodes (e.g., carbon materials and binder materials) are known in the art.
Statement 27. The cathode according to Statement 25 or 26, where the cathode comprises sulfur at 50-85% by weight (based on the total weight of the cathode). In various examples, a cathode has a sulfur loading of 50-70%, 71-85%, 72-85%, 73-85%, 74-85%, 75-85%, or 80-85% by weight, based on the total weight of the cathode.
Statement 28. A device comprising a cathode according to any one of Statements 25-27.
Statement 29. The device according to Statement 28, where the device is a lithium-sulfur battery or a sodium-sulfur battery.
Statement 30. The device according to Statement 29, where the battery further comprises an anode and/or one or more electrolyte and/or one or more current collector and/or one or more additional structural components.
Statement 31. The device according to Statement 30, where the one or more additional structural component(s) is/are chosen from bipolar plates, external packaging, electrical contacts/leads to connect wires, and combinations thereof.
Statement 32. The device according to any one of Statements 29-31, where the lithium-sulfur battery comprises a plurality of cells, each cell comprising one or more cathode according to any one of Statements 25-27, and optionally, one or more anode(s) and/or cathode(s), electrolyte(s), and current collector(s).
Statement 33. The device according to Statement 32, where the lithium-sulfur battery comprises 1 to 500 cells.
Statement 34. A device according to any one of claims 29-33, where the device exhibits one or more of the following: 1) an areal capacity of at least 3 mAh/cm² and/or a stabilized capacity of at least 2.2 mAh/cm² after 150 cycles or more at 0.2 C (corresponding to a capacity retention of at least 73%); or 2) a capacity of at least 1.5 mAh/cm² at a rate of 1 C.

The following example is presented to illustrate the present disclosure. It is not intended to be limiting in any matter.

### EXAMPLE 1

The following describes examples of MOF-sulfur compositions, composite materials, methods, cathodes, and batteries of the present disclosure, and characterization of batteries of the present disclosure.

Sulfur Encapsulation by MOF-Derived CoS₂ Hosts for High-Performance Li—S Batteries. Li—S batteries have attracted great attention for their combined advantages of potentially high energy density and low cost. To tackle the capacity fade from polysulfide dissolution, a confinement approach was developed by in situ encapsulating sulfur with a MOF-derived CoS₂ in a carbon framework (S/Z-CoS₂), which in turn was derived from a sulfur/ZIF-67 composite (S/ZIF-67) via heat treatment. The formation of CoS₂ was confirmed by X-ray absorption spectroscopy (XAS) and its microstructure and chemical composition were examined through cryogenic scanning/transmission electron microscopy (Cryo-S/TEM) imaging with energy dispersive spectroscopy (EDX). Quantitative EDX suggests that most of the sulfur resides inside the cages, rather than externally. S/hollow ZIF-67-derived CoS₂ (S/H-CoS₂) was rationally designed to serve as a control material to explore the efficiency of such hollow structures for confining elemental sulfur. Cryo-STEM-EDX mapping indicates that S/H-CoS₂ contains sulfur both inside and outside of the host, despite its high void volumetric fraction of ˜85%. The S/Z-CoS₂ composite exhibited highly improved battery performance, when compared to both S/ZIF-67 and S/H-CoS₂, due to both the physical confinement of sulfur inside the host and strong chemical interactions between CoS₂ and sulfur/polysulfides. Electrochemical kinetics investigation revealed that the CoS₂ could serve as electrocatalysts to accelerate the redox reactions. This composite could deliver a reversible capacity of 750 mAh/g after 200 cycles at 0.2 C. At high areal sulfur loading, the electrodes could provide an areal capacity of 2.2 mAh/cm² after 150 cycles at 0.2 C and 1.5 mAh/cm² at 1 C. This novel material provides valuable insights for further development of high-energy, high-rate and long-life Li—S batteries.

A procedure was developed for the in situ encapsulation of sulfur nanoparticles by ZIF-67, followed by heat treatment, in vacuum, to carbonize the MOF (rendering it conductive) so as to enhance the conductivity of the composite. More importantly, it was found that after the heat treatment, the ZIF-67 was converted, by sulfur, to CoS₂ within the carbon matrix. The CoS₂ served as a conductive host to help encapsulate sulfur into its interior structure. Moreover, it has been reported that cobalt pyrite, CoS₂, is a sulfiphilic semi-metallic material that could effectively adsorb LiPSs, by chemical interactions, and, furthermore, could also serve as an electrocatalyst to boost Li—S battery performance by enhancing the redox reactions of polysulfides. Thus, the resulting composite material, sulfur encapsulated by CoS₂, embedded in a conducting carbon matrix derived from ZIF-67 (S/Z-CoS₂), would synergistically benefit from their combined properties. First, the conductive host, CoS₂ embedded in the carbon matrix, can facilitate electron transfer and ionic transport, increasing the utilization of active material during cycling and enhancing rate performance. Secondly, due to the in situ encapsulation, LiPSs diffusion can be largely suppressed by physical entrapment. Thirdly, CoS₂ can serve as both an adsorbent and electrocatalyst for LiPSs. Polar CoS₂ can adsorb polysulfides by chemical interactions and, more importantly, promote the kinetics of the redox reactions. In addition, the materials were obtained by a facile synthesis procedure amenable to large-scale production. With these advantages, the S/Z-CoS₂ composite could deliver, in Li—S cells, a high capacity of 750 mAh g⁻¹ for over 200 cycles at 0.2 C with excellent cycle performance at both low and high current densities. An outstanding rate performance was also achieved at 5.0 C. S/Z-CoS₂ electrodes with stable and high-areal capacity represent attractive and feasible high energy-density materials for commercial implementation of Li—S batteries.

Experimental section. Preparation of S/ZIF-67. Sulfur nanoparticles were synthesized according to previously known methods. In a typical synthesis procedure, 0.015 mol of Na₂S₂O₃ dissolved in 50 mL of water were added to 500 mL of a 30 mM sulfuric acid solution containing 1 wt. % of polyvinylpyrrolidone (PVP, Mw 40,000). After reaction for 2 hours the resulting sulfur nanoparticles were separated by centrifugation. The obtained particles were homogeneously dispersed in 50 mL of methanol with 2 wt. % PVP. 1.95 mmol of Co(NO₃)₂.6H₂O were dissolved in the sulfur/PVP methanol dispersion and the mixture was stirred for 30 min. 5.85 mmol of 2-methylimidazole were added to 50 mL of methanol and after uniformly mixing, the 2-methylimidazole solution was quickly poured into the sulfur mixture. After stirring for 5 min, the mixture was aged for 24 hours at room temperature.

Preparation of S/Z-CoS₂. S/Z-CoS₂ was synthesized by heat treatment under vacuum. The as-prepared S/ZIF-67 composite was sealed in a quartz tube under vacuum, followed by heating at 300° C. for 7 h (h=hour(s)). Preparation of hollow ZIF-67. To obtain solid ZIF-67, 1.95 mmol of Co(NO₃)₂.6H₂O and 5.85 mmol of 2-methylimidazole were dissolved in 50 mL of methanol. After fully dissolving, the 2-methylimidazole solution was quickly added into the former solution and after stirring for 5 min, the mixture was aged for 24 hours at room temperature. Tannic acid has been reported to be able to etch the solid MOF to form hollow materials. Thus, the solid ZIF-67 was further treated with tannic acid through a modified method. Typically, 50 mg of solid ZIF-67 particles were dispersed in 50 mL of methanol containing 500 mg of tannic acid. After reaction for 1 hour, the particles were collected by centrifugation.

Preparation of S/H-CoS₂. Sublimed sulfur, and as-prepared hollow ZIF-67 were mixed in a mortar and then sealed under vacuum. After heat treatment at 300° C. for 7 hours, S/H-CoS₂ was obtained.

Preparation of Li₂S₆. A Li₂S₆ solution was prepared by dissolving stoichiometric amounts of Li₂S and elemental S into 1,2-dimethoxyethane and 1,3-dioxolane (DME/DOL, 1:1 in volume) at 60° C. overnight in an argon glovebox.

Material characterization. X-ray characterization: Co K-edge X-ray absorption spectroscopy (XAS) measurements were conducted at the F-3 beamline of the Cornell High Energy Synchrotron Source (CHESS) in transmission mode from 150 eV below the metal edge out to k=12 using nitrogen-filled ion chambers. A Co metal foil spectrum was collected concurrently, and served as a standard to calibrate the incident X-ray energy. XANES (X-ray absorption near edge structure) and EXAFS (extended X-ray absorption fine structure) spectra were normalized and analyzed using the DEMETER (Athena and Artemis) software package. Background removal and spectral normalization were carried out using Athena, and EXAFS fitting was performed with the Artemis package using standard procedures. Fourier transformed EXAFS spectra were obtained by applying a Hanning window from 3 to 10 Å⁻¹ with k²-weighting. Spectra of S/ZIF-67 and S/Z-CoS₂ were fitted with standard ZIF-67 and CoS₂ crystal structures, respectively. X-ray diffraction (XRD) patterns were recorded using a Rigaku Ultima VI diffractometer with a Cu Kα source. Diffraction patterns were collected at a scan rate of 5° min⁻¹ and with an increment of 0.02°.

Cryogenic electron microscopy characterization. Sulfur-containing samples were dispersed in ethanol and transferred to Cu TEM transmission electron microscope (TEM) grids with a lacey carbon film (Electron Microscopy Sciences, EMS). The TEM grids were loaded into a Gatan model 914 single-tilt cryo-holder under nitrogen gas, at near liquid N₂ temperature. The holder kept the sample at a stable temperature of about −183° C. to suppress sulfur sublimation. Cryogenic Bright-field (BF) TEM and High-angle annular dark-field (HAADF) STEM images were acquired using a field-emission-gun (FEG) FEI Tecnai F-20 microscope. XEDS elemental mapping was performed using an Oxford X-Max detector. EDX maps were acquired for 10-15 min to achieve more than 100 counts/pixel for sulfur and more than 50 counts/pixel for cobalt before noticeable sample drift was observed. STEM-EDX mapping was set at a beam voltage of 200 keV, a beam dose of 6-7 e/(nm²·s) and a pixel size of 128×128. Beam damage of STEM-EDX maps has been routinely examined before and after EDX mapping. For Cryo-SEM imaging, sulfur-containing samples were loaded onto a single-crystal Si wafer on a cryo-SEM stage at −165° C. with a surrounding cold finger set at −183° C. to prevent ice contamination. Samples were imaged using a FEI Strata 400 STEM FIB electron microscope with a beam voltage of 30 keV and beam current of 1 nA.

Electrochemical tests. The cells were assembled with the prepared sulfur composite electrodes (composite: Super P:PVDF=80:15:5 by weight), lithium foil, electrolyte and separator (Celgard 2300) in an argon filled glovebox with low H₂O and O₂ levels (<0.3 ppm). The electrolyte was 1.0 M lithium bis(trifluoromethane) sulfonamide (LiTFSI) dissolved in a mixed solvent of 1,3-dioxolane (DOL) and 1,2-dimethoxyethane (DME) (1:1, v/v) with 0.2 M LiNO₃ as an additive. The galvanostatic charge/discharge and cyclic voltammetry (CV) tests were performed on an Arbin battery cycler (Arbin, BT 2000, USA) between 1.7 to 3.0 V (vs. Lr/Li). The specific capacity and C rates (1 C=1675 mA h g⁻¹) were calculated based on the sulfur mass in the electrode.

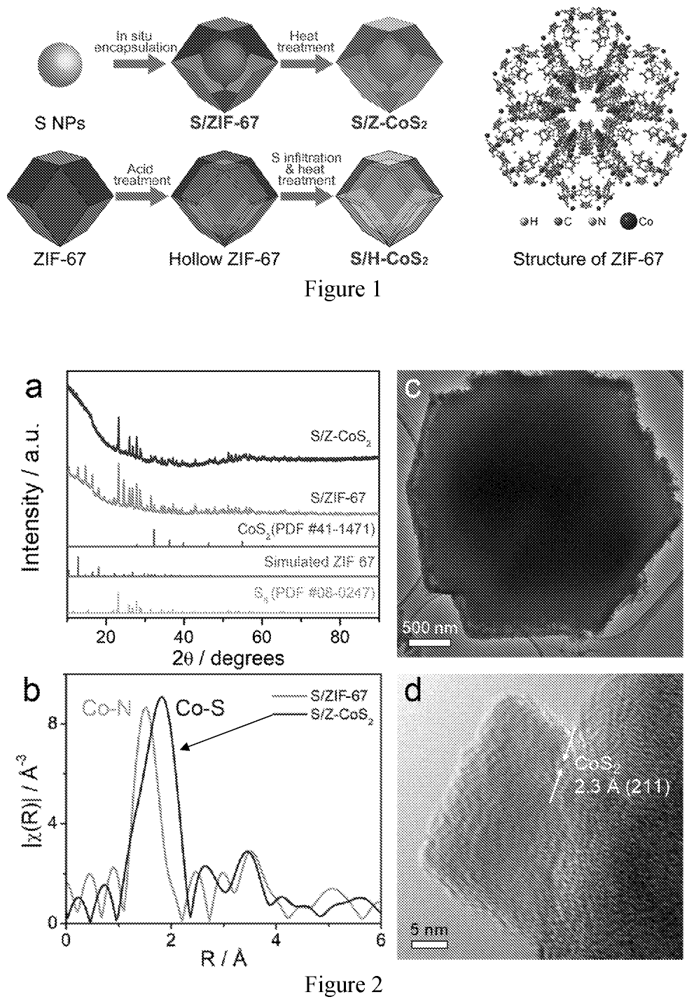

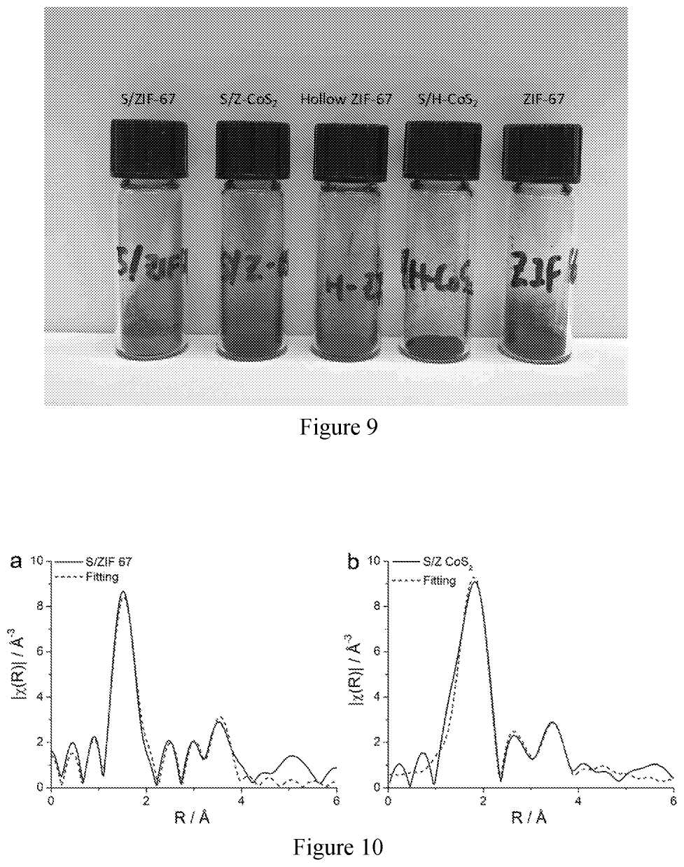

Results and discussion. Materials synthesis and characterization. The S, composited with CoS₂ in the carbon matrix derived from ZIF-67 (S/Z-CoS₂), was synthesized as illustrated in FIG. 1. Sulfur nanoparticles (NPs) were prepared via a previously known method. The sulfur NPs were in situ encapsulated by ZIF-67 in the presence of polyvinylpyrrolidone (PVP). To increase the conductivity of the composite, the obtained S/ZIF-67 composite was annealed under vacuum to partially carbonize the ZIF-67. FIG. 9 shows that the purple S/ZIF-67 changed to black after heat treatment. X-ray diffraction (XRD) patterns (FIG. 2a) indicate that the S/ZIF-67 composite is a mixture of ZIF-67 and sulfur, and cubic-phase CoS₂ (JCPDS No. 41-1471) formed after heat treatment. Distinct diffraction peaks at 27.8, 32.5, 36.2, 39.5, 46.5 and 55.2° can be indexed to the (111), (200), (210), (211), (220) and (311) crystal planes of CoS₂, respectively. The broad peaks of CoS₂ indicate a small crystal (domain) size and, based on the Scherrer equation, the average size of the crystallites was calculated to be 20˜25 nm.

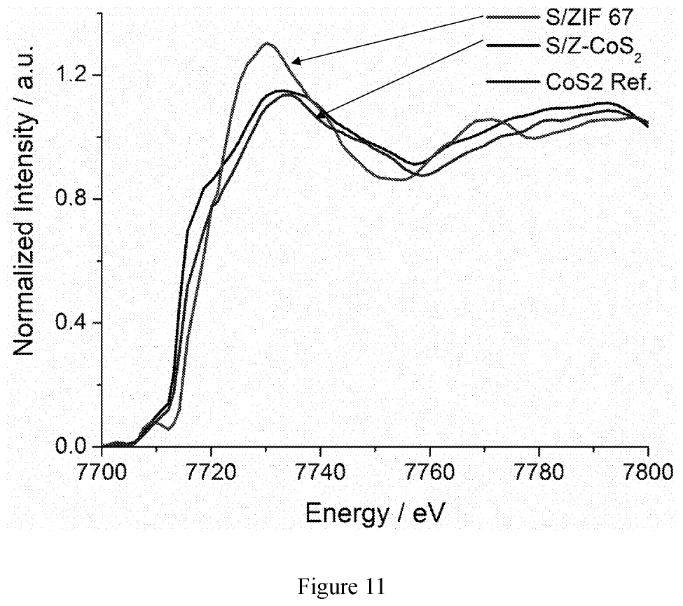

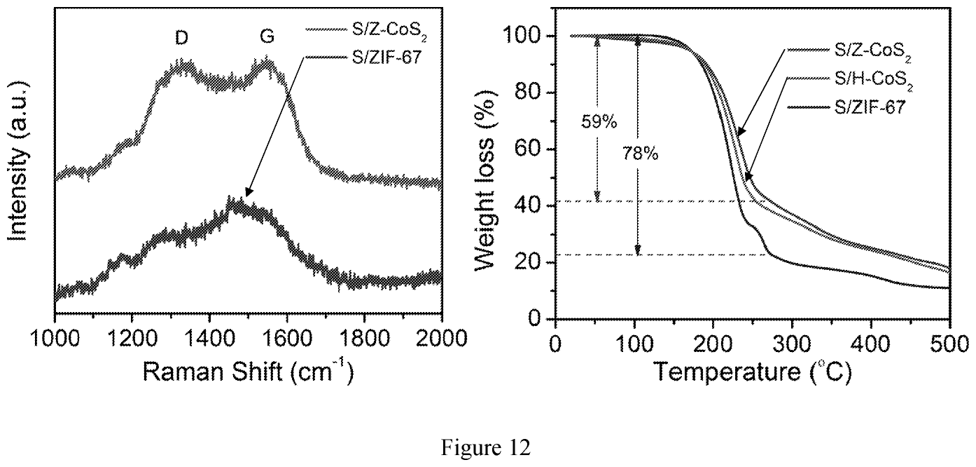

In order to further confirm the formation of CoS₂ in the S/ZIF-67 derived composite after heat treatment, powder X-ray absorption spectroscopy (XAS) measurements were performed at the Cornell High Energy Synchrotron (CHESS). The extended X-ray absorption fine structure (EXAFS) spectra exhibited a significant change between S/ZIF-67 and S/Z-CoS₂ (FIG. 2b). The first shell peak, representing the chemical bond between Co and its closest neighbors, at around 1.5 ∈ in the S/ZIF-67 sample shifted to about 1.9 Å in S/Z-CoS₂ (both without phase correction), suggesting a transformation from a Co—N bond in ZIF-67 to a Co—S bond in S/ZIF-67-derived CoS₂ with a carbon framework (S/Z-CoS₂). The Co—N and Co—S bond lengths were calculated to be 1.988 Å and 2.253 Å, respectively, through EXAFS fitting using ZIF-67 and CoS₂ standards, respectively (FIG. 10). Powder X-ray absorption near edge structure (XANES) spectra at the Co—K edge further confirmed that the majority of Co in ZIF-67 was successfully converted to CoS₂, as evidenced by the shift in the Co K-edge energy, as well as the similar spectral features between S/Z-CoS₂ and the CoS₂ standard (FIG. 11). Moreover, the signature pre-edge peak feature for S/ZIF-67 disappeared after heat treatment, indicating a decomposition of the MOF structure. In addition, the microstructure of the S/Z-CoS₂ composite particles was examined by bright-field (BF) TEM under cryogenic conditions. As shown in FIG. 2c, S/Z-CoS₂ exhibits a projected hexagonal symmetry with a rough surface morphology. The atomic-scale BF-TEM image in FIG. 2d reveals a lattice d-spacing of 2.3 521 , which matches the (211) lattice plane of CoS₂. Raman spectra of the composites before and after the heat treatment are presented in FIG. 12a. Two new dominant peaks were found at 1350 cm⁻¹ and 1585 cm⁻¹ corresponding to the characteristic D and G bands of the carbon matrix, respectively, demonstrating that ZIF-67 was carbonized during the heat treatment.

About 78 wt. % of elemental sulfur was incorporated in the S/ZIF-67, while it was 59 wt. % in the S/Z-CoS₂ as determined from thermogravimetric analysis (TGA), FIG. 12b, indicating that about 20 wt. % of elemental sulfur was consumed in forming CoS₂, indicating the formation of CoS₂ in the carbon framework after the heat treatment of S/ZIF-67.

Traditionally, researchers have employed scanning/transmission electron microscopy (SEM/TEM) to study the microscale and nanoscale distribution of sulfur in host materials. However, under the high-vacuum conditions (10⁻⁵ Pa) of conventional electron microscopes, elemental sulfur readily sublimes, and some of the sublimed sulfur can redistribute to other parts of the sample, precluding the intrinsic distribution of sulfur from being reliably characterized. Previous work has shown that cryogenic scanning/transmission electron microscopy (cryo-S/TEM) can effectively suppress sulfur sublimation by keeping the sample at near liquid N₂ temperature, enabling a reliable characterization of the distribution of sulfur in sulfur-host material composites.

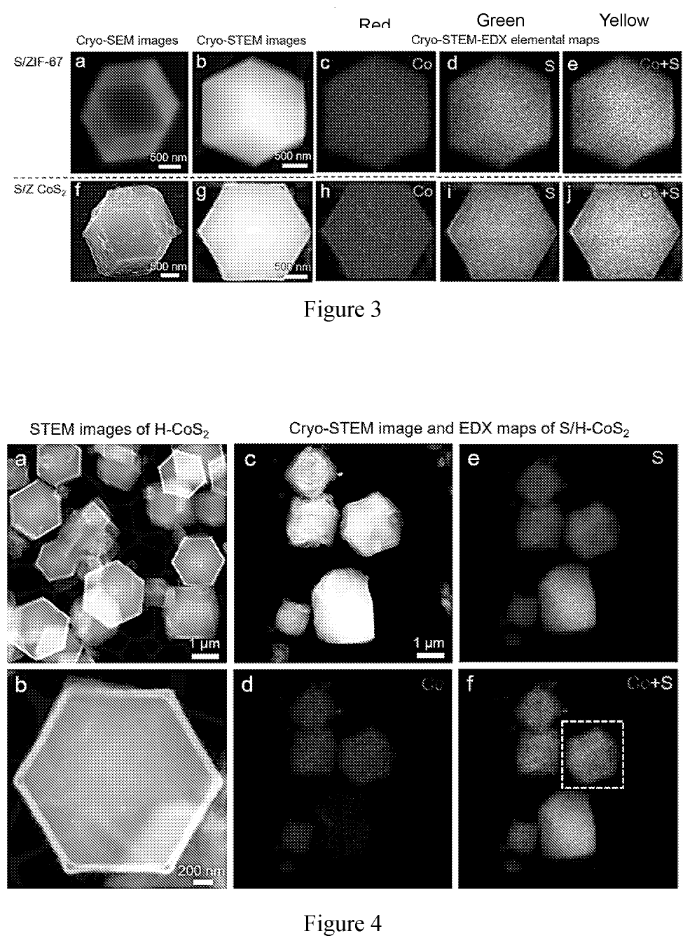

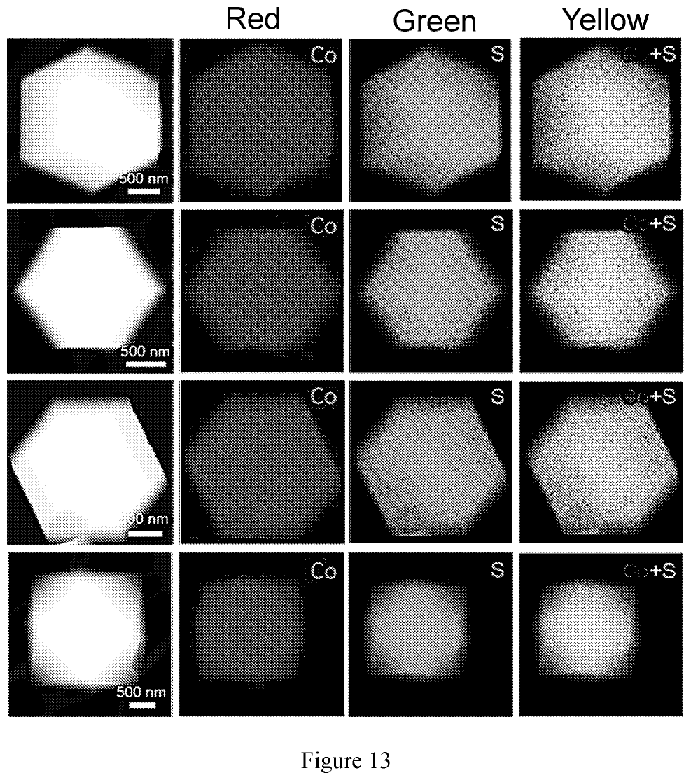

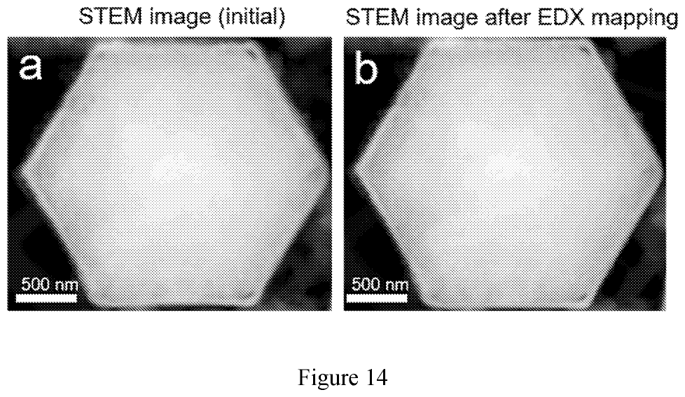

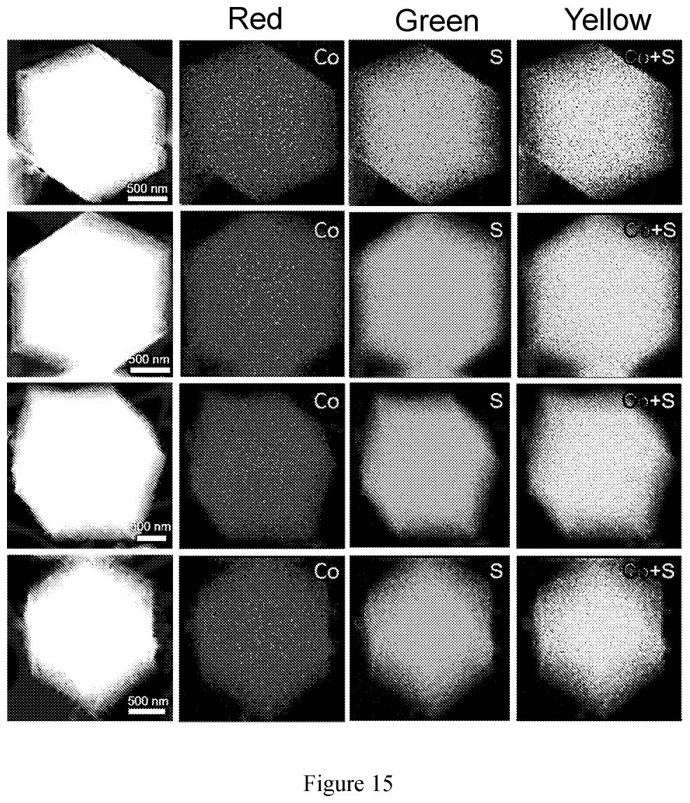

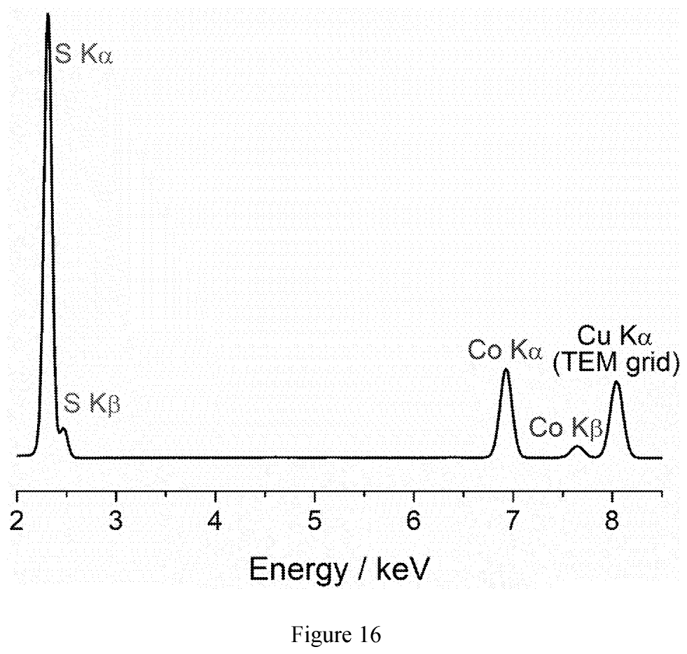

The cryo-SEM image of the S/ZIF-67 composite displays a 2-3 μm particle with the typical geometry of a rhombic dodecahedron with twelve rhombic faces (FIG. 3a). The 2D projected geometry of a rhombic dodecahedron can be either a hexagon or rhombus. Cryo-STEM image of S/ZIF-67 composite at T=−183° C. shows another particle with a hexagonal symmetry and well-defined sharp edges (FIG. 3b). The corresponding EDX elemental maps in FIGS. 3c-e demonstrate the homogenous distribution of Co and S elements in the composite particle at the nanometer scale, which is supported by further examination of the elemental distribution of Co and S in four other different regions (FIG. 13). The signals in S and Co maps reached more than 100 and 50 counts/pixel, respectively, before noticeable sample drift and beam damage was observed (FIG. 14). Considering that the signal-to-noise (S/N) ratio is proportional to \sqrt{N}, S and Co elemental maps have a high S/N ratio of more than 10 and 7, respectively. This confirms the successful encapsulation of sulfur in the ZIF-67 cage. In contrast to the well-defined sharp edges in FIGS. 3a-b, S/Z-CoS₂, obtained by heat treatment, exhibits a rougher surface morphology as shown in the cryo-SEM image in FIG. 3f, as was previously confirmed by BF-TEM images (FIG. 2d) to have CoS₂ nanoparticles on the surface. The Cryo-STEM image of a S/Z-CoS₂ particle reveals a size of 2-3 μm with hexagonal symmetry, similar to S/ZIF-67 (FIG. 3g). The corresponding EDX elemental maps of Co, S and Co vs. S again demonstrate the homogenous elemental distribution of Co and S in the S/Z-CoS₂ composite, which is further evidenced by the EDX maps of other different S/Z-CoS₂ composite particles (FIG. 15). To quantitatively examine the S and Co content in the S/Z-CoS₂ composite, EDX spectral analysis was performed and the S to Co atomic ratio was calculated to be 6.7:1 based on the S and Co K-edges peak intensity ratio (FIG. 16), indicating that elemental sulfur stays inside the CoS₂ cages where the S/Co ratio is 2:1. This is important to the instant design, differing from the conventional strategy in which sulfur stays outside the host material, such as the ones in previous studies of a layered metal sulfide, porous carbon, and porous metal oxide. The homogenous encapsulation of sulfur in the matrix formed by CoS₂ and carbon can facilitate both electronic transport and the electrochemical utilization efficiency of the insulating sulfur.

The enhanced battery performance of the S/Z-CoS₂ composite, compared to S/ZIF-67 (vide-supra), can be attributed to the unique strategy of enclosing sulfur into the ZIF-derived CoS₂. A common approach, in the literature, to constrain elemental sulfur with a hollow or porous host material, was through a traditional sulfur melt-infusion method at 150° C. or sulfur vaporization at higher temperatures. Thus, in order to compare the instant method with the traditional strategy, a control group of hollow ZIF-67 was prepared by etching the as-synthesized ZIF-67 using tannic acid (see FIG. 1 for an illustration of the detailed preparation). In this case, hollow ZIF-67 was prepared by etching solid ZIF-67 using tannic acid (see FIG. 9 for the color of hollow ZIF-67). Subsequently, sulfur was infiltrated into the hollow structure under the same heat treatment so that ZIF-67 was transformed to CoS₂ embedded in a carbon matrix, and sulfur would sublime and infiltrate into the hollow host material at the same time. The formed composite is denoted as S/H-CoS₂. Since the image intensity in ADF-STEM images is proportional to atomic number as well as atomic density, a lower intensity indicates a lower atomic density in the material with the same element. Based on this argument, FIGS. 4a-4b suggest that the hollowed architecture of H-ZIF-67 was successfully obtained. HAADF-STEM images indicate that μm-sized ZIF-67 precursors generate an inner void with a shell thickness of about 100 nm. A hollow ZIF-67 with a particle size of 2 μm and a shell thickness of 100 nm will result in a high theoretical void volume fraction of around 85% in the whole particle based on the geometry of a rhombic dodecahedron (Volume,

$$V = \frac{16 \sqrt{3}}{9} {a}^{3} ,$$

where a is the edge length).

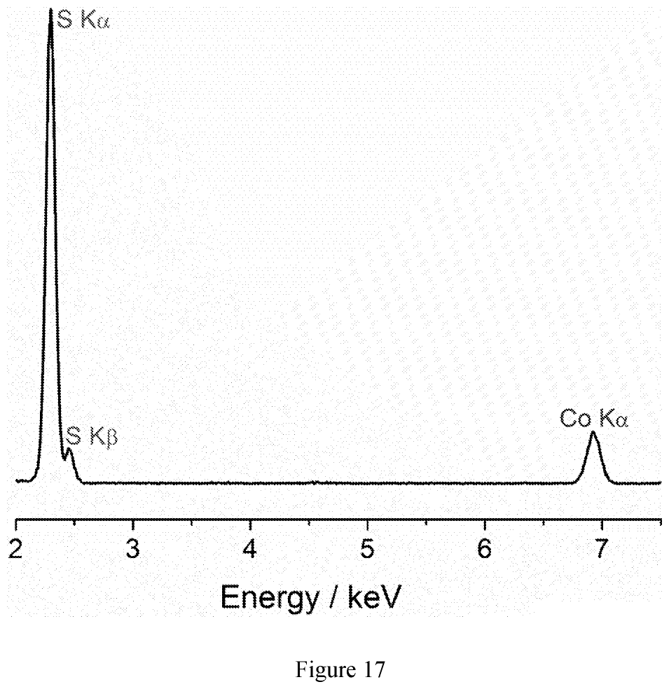

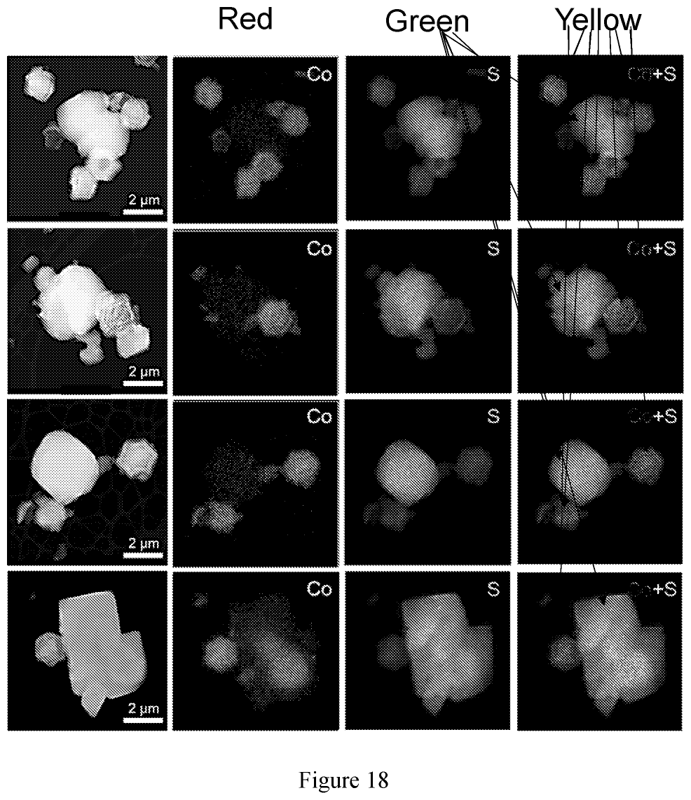

The microstructure and chemical composition of S/H-CoS₂ composites were examined through Cryo-STEM-EDX mapping. As shown in the STEM image in FIG. 4c, the void of hollow ZIF-67 hosts was occupied with possibly/likely elemental sulfur. EDX elemental maps of S/H-CoS₂ unveils the local distribution of elemental sulfur both inside and outside of the hollow ZIF-67 host (FIGS. 4d-4f). Color overlays of Co and S maps in FIG. 4f indicate that hollow ZIF-67 hosts are, in fact, filled with elemental sulfur (four composite particles in yellow/orange). The EDX spectrum, extracted from one particle in the white dashed box, further suggests a S/Co atomic ratio of 9.5:1, which is significantly larger than the theoretical S/Co ratio of 2:1 in CoS₂ (FIG. 17). This indicates that a considerable amount of sulfur, inside the hollow ZIF-67, could exist in the form of elemental sulfur. Interestingly, an isolated μm-sized particle in bright green in FIG. 4f was ascribed to be a pure elemental sulfur particle outside of the Co-containing hollow ZIF-67 host. Further examination of four other regions in S/H-CoS₂ clearly confirms that 2-5 μm pure elemental sulfur particles co-exist and remain external to the hollow ZIF-67 host (FIG. 18). Despite the fact that hollow ZIF-67 has a high void volume fraction of around 85%, a considerable amount of elemental sulfur remains outside as sulfur particles either in physical contact with or isolated from the hollow host, in a way that is similar to a previous study of a porous iron oxide. In summary, S/hollow ZIF-67-derived CoS₂ (S/H-CoS₂) has been rationally designed to serve as a control group with elemental sulfur present both inside and outside of the host material. S/H-CoS₂ together with an integrated S/Z-CoS₂ composite is later be compared (vide infra) in battery tests, to explore the correlation between structural design and battery performance.

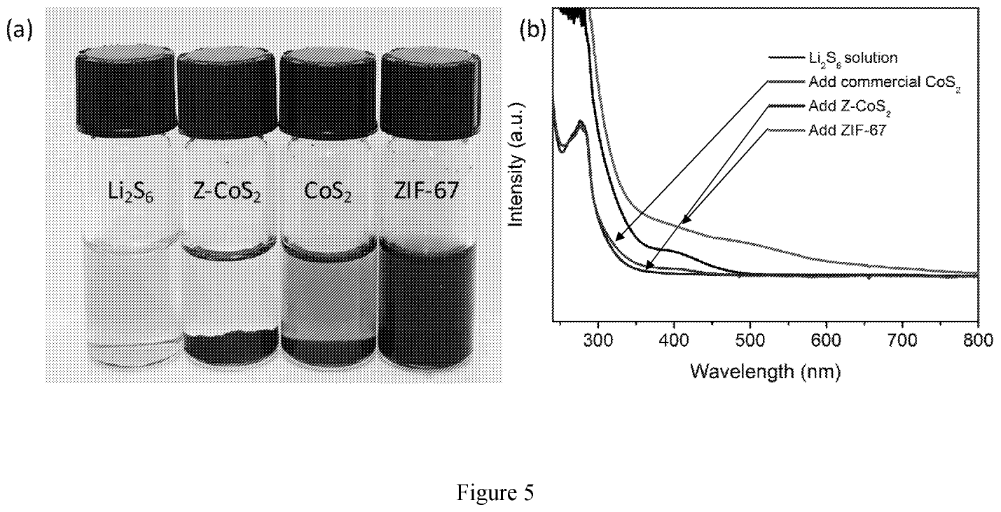

It was posited that the polar sulfur host obtained, CoS₂ in a carbon matrix derived from ZIF-67 (Z-CoS₂), has a strong adsorption towards polar LiPSs (lithium polysulfides). To demonstrate/test the effectiveness of Z-CoS₂ as host material for suppressing the diffusion of LiPSs, the adsorption ability of polar Z-CoS₂ towards LiPSs was tested. CoS2, in a carbon matrix without sulfur (Z-CoS₂), was obtained by subliming sulfur under high temperature (300° C.) for 6 hours in a flow furnace. Z-CoS₂ was then mixed with a 1 mM Li₂S₆ in DOL/DME (1:1, v/v) solution as a representative polysulfide. As shown in FIG. 5a, it is evident that the addition of Z-CoS₂ to the polysulfide solution turns the color of the Li₂S₆ from yellow to colorless (immediately), suggesting that Z-CoS₂ has a strong (and fast) adsorption capability for LiPSs. Thus, there would be the expectation that during cycling, Z-CoS₂ can help immobilize the LiPSs and greatly mitigate capacity fade. As a comparison, commercial CoS₂ and ZIF-67 were also added to the polysulfide solution. The commercial CoS₂ gave rise to a slight color change, indicating that CoS₂ is beneficial for constraining LiPSs, as previously reported. However, ZIF-67 did not cause any color change. Instead the solution changed to pinkish, suggesting that ZIF-67 lacks the ability to restrain the LiPSs from diffusing and, even worse, ZIF-67 is likely decomposing slightly with Co²⁺ diffusing into the electrolyte (giving rise to the pink coloration). UV-Vis spectra (FIG. 5b) further indicated that Z-CoS₂ has a strong entrapment ability to polysulfides, due to both chemical interactions and physical constraints. The strong and fast affinity of Z-CoS₂ for LiPSs could improve cycling stability of S/Z-CoS₂ composites.

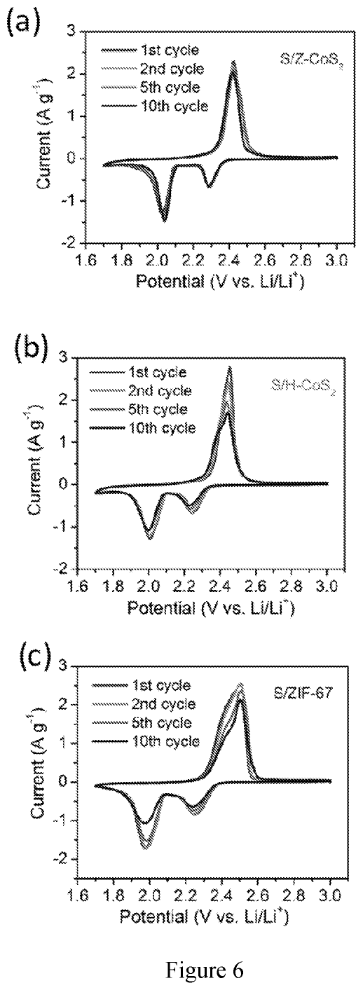

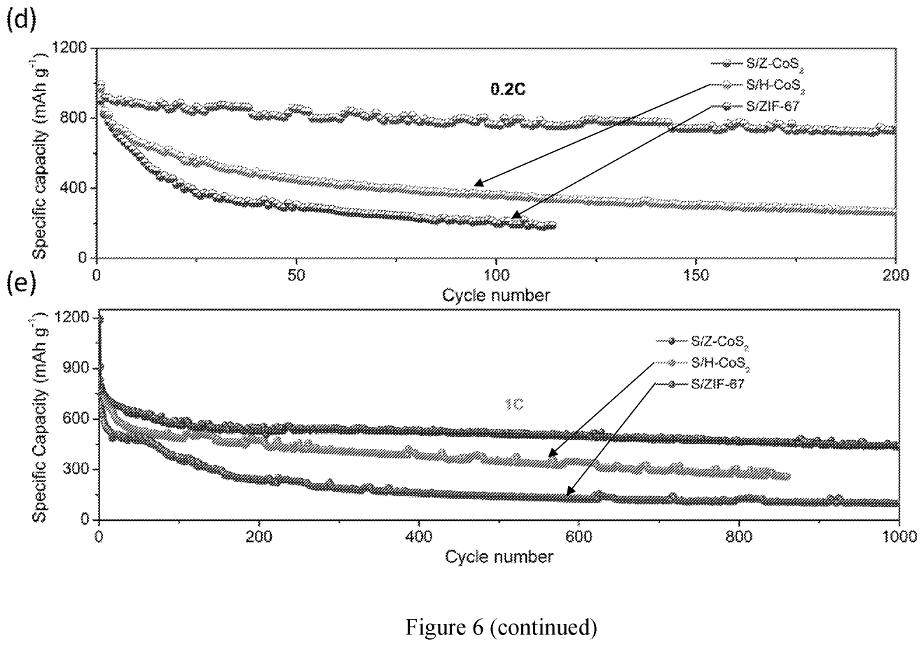

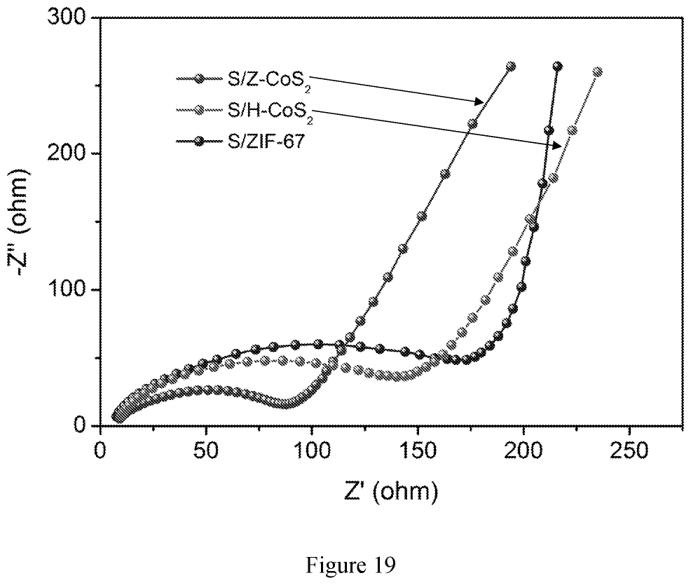

Electrochemical performance. Coin cells with S/Z-CoS₂, S/ZIF-67 and S/H-CoS₂ as cathode materials were prepared to evaluate their electrochemical performance. Cyclic voltammograms (CV) of these materials were obtained over the voltage range of 1.7-3.0 V at a scan rate of 0.1 mV (FIGS. 6a-c). For S/Z-CoS₂, two well-defined reduction peaks at 2.28 and 2.05 V were observed, corresponding to the reduction of sulfur to high-order lithium polysulfides Li₂Sₓ (4≤x≤8) as well as lithium polysulfides to solid-state Li₂S₂/Li₂S, respectively, while the anodic peak could be assigned to the oxidation of Li₂S₂/Li₂S to S₈. In the case of S/ZIF-67, the two reduction peaks were found at lower potentials of 2.22 V and 1.98 V, respectively. The potential shifts are likely due to the low electronic conductivity of ZIF-67, which results in slower redox kinetics. As mentioned previously, the heat treatment partially carbonizes the ZIF-67 material to produce CoS₂ in the matrix. Benefitting from the generated carbon as well as CoS₂, the overall conductivity of the composite material is highly enhanced, facilitating electronic transfer. Due to the similar reaction pathways, S/H-CoS₂ has higher conductivity than S/ZIF-67, leading to a positive shift of the reduction peaks (2.23 and 2.01V) compared to S/ZIF-67. However, the external elemental sulfur on the surface of the host material impedes electron transfer between particles, so that the reaction kinetics are slower than S/Z-CoS₂. To compare the conductivity of the materials, electrochemical impedance spectra (EIS) of S/Z-CoS₂, S/ZIF-67 and S/H-CoS₂ cathodes are presented in FIG. 19. S/Z-CoS₂ exhibits the smallest semicircle diameter in the high-frequency region, suggesting that S/Z-CoS₂ has the faster charge transfer process. In addition, FIGS. 6a-c show that after 10 cycles, the peak positions and intensities were not changed for S/Z-CoS₂, indicating the stable cycling stability of the material. In contrast, both S/ZIF-67 and S/H-CoS₂ exhibited dramatic shifts, due to the increased resistance during cycling and severe shuttling problem.

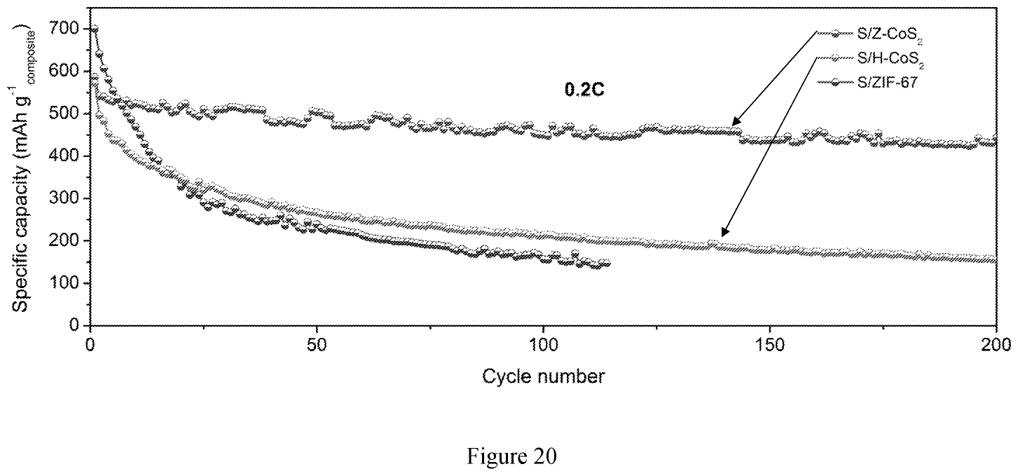

The cycling performance of these three electrodes are compared at a current density of 0.2 C (FIG. 6d). S/Z-CoS₂, S/ZIF-67 and S/H-CoS₂ delivered initial capacities of 993, 900, and 970 mAh g⁻¹, respectively. However, after only 50 cycles, the discharge capacity of S/ZIF-67 dropped rapidly to 300 mAh g⁻¹, corresponding to a capacity retention of only 30%. The rapid capacity decay is due to the increased resistance of the composite during cycling, which is in excellent agreement with FIG. 6c. The S/H-CoS₂ electrode delivered a somewhat higher capacity with slightly better capacity retention than S/ZIF-67 because of the increased electrical conductivity, caused by heat treatment, and chemical interactions between CoS₂ and LiPSs during cycling. However, with minimal chemical adsorption effects, the capacity fade was still severe with only 28% retention after 200 cycles. In contrast, S/Z-CoS₂ electrodes exhibited a significantly enhanced cycling stability. A much higher capacity of 750 mAh g⁻¹ was achieved with an excellent capacity retention of 76% after 200 cycles. The improved stability is likely due to the increased conductivity of the material, compared to S/ZIF-67, and mitigated loss of active material, through LiPSs dissolution, by both physical confinement and the chemical interactions of LiPSs with CoS₂ in the carbon matrix. The capacity values obtained based on the mass of the composite are shown in FIG. 20. The prolonged cycling stability of the materials were further tested at 1 C (FIG. 6e). S/Z-CoS₂ exhibited a highly stabilized capacity of 440 mAh g⁻¹ after 1000 cycles, corresponding to a low average capacity drop rate of 0.04% per cycle.

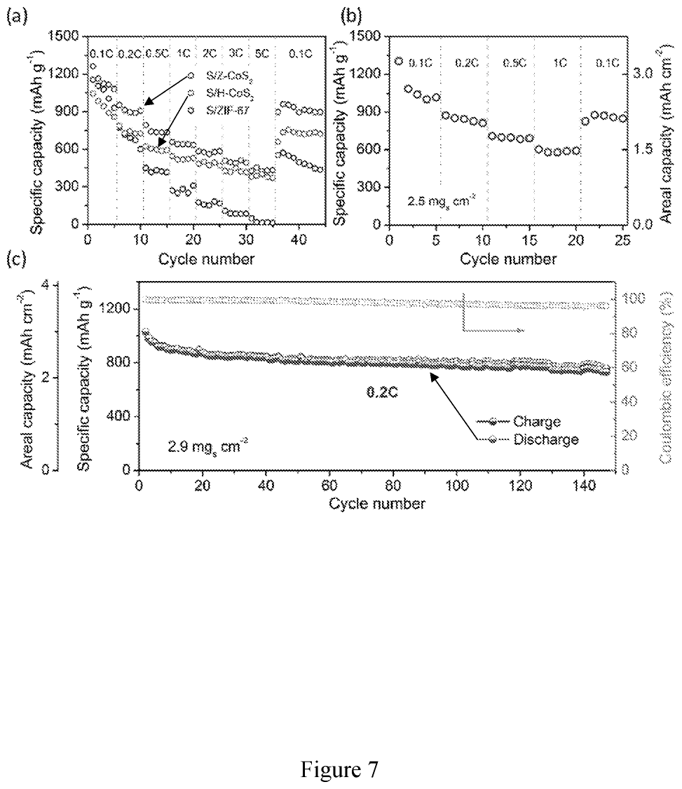

The rate capabilities and the electrode kinetics were investigated at various current densities (FIG. 7a). As the current density was increased stepwise from 0.1 to 5 C, the S/Z-CoS₂ delivered high capacity values of 1100, 910, 740, 640, 580, 490 and 430 mAh g⁻¹, respectively. When the current density was decreased back to 0.1 C, a capacity of 930 mAh g⁻¹ was obtained, indicating a high structural stability, even at high C-rates. Compared with S/Z-CoS₂, the S/ZIF-67 shows much lower discharge capacities at various current densities, and almost no capacity at current densities higher than 2 C. The dramatically low capacities are caused, at least in part, by the low conductivity of the composite material. Owing to the higher conductivity of H-CoS₂, the rate capability of S/H-CoS₂ is better than S/ZIF-67 at high current densities. However, without physical constraint, the ineffective

LiPSs confinement of H-CoS₂ results in relatively low capacities at low C-rates. It is worth noting that S/H-CoS₂ and S/Z-CoS₂ have similarly high capacities at high current densities. This could be due to CoS₂, serving as an electrocatalyst, could favorably affect the redox reactions. Ascribed to the improved conductivity and efficient LiPSs entrapment by both physical confinement and chemical adsorption effects, S/Z-CoS₂ exhibited the best performance in terms of redox kinetics and cycling stability.

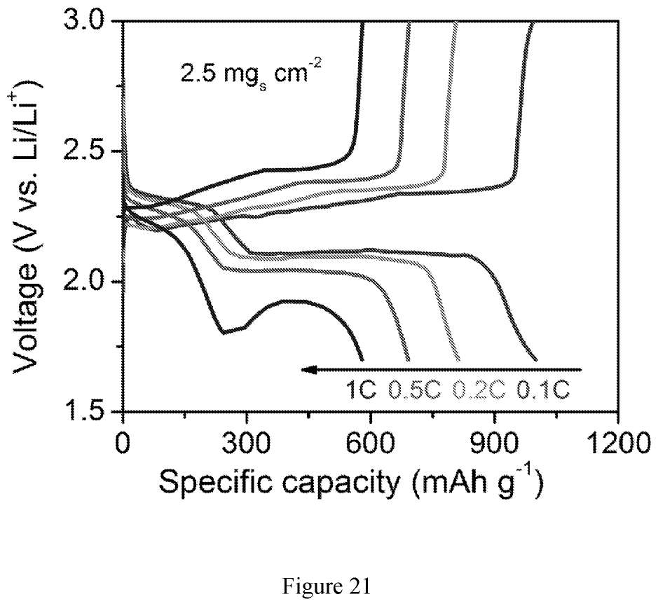

High sulfur loading of the electrode composite is of great significance for the practical use of Li—S batteries. Thus, S/Z-CoS₂ electrodes with high areal sulfur loadings of 2.5-2.9 mg cm⁻² were further tested. FIG. 7c presents cycling performance of the high-loading electrodes cycled at 0.2 C for 150 cycles. An initial discharge capacity of 1030 mAh g⁻¹ was achieved, corresponding to an areal capacity of 3 mAh cm⁻². After 150 cycles, a high and stabilized specific capacity of 750 mAh g⁻¹, corresponding to 2.2 mAh cm⁻², was obtained. The stable cycling performance of high-loading sulfur electrodes of S/Z-CoS₂ is ascribed to the high conductivity of S/Z-CoS₂ and efficient confinement of LiPSs by both physical and chemical entrapment. The rate performance of high-loading electrodes in FIG. 7b shows that the S/Z-CoS₂ electrode can provide a high areal capacity of 1.5 mAh cm⁻² even at a high C rate of 1 C. Two well-defined discharge plateaus were observed at various current densities (FIG. 21), illustrating the fast redox kinetics of the electrodes.

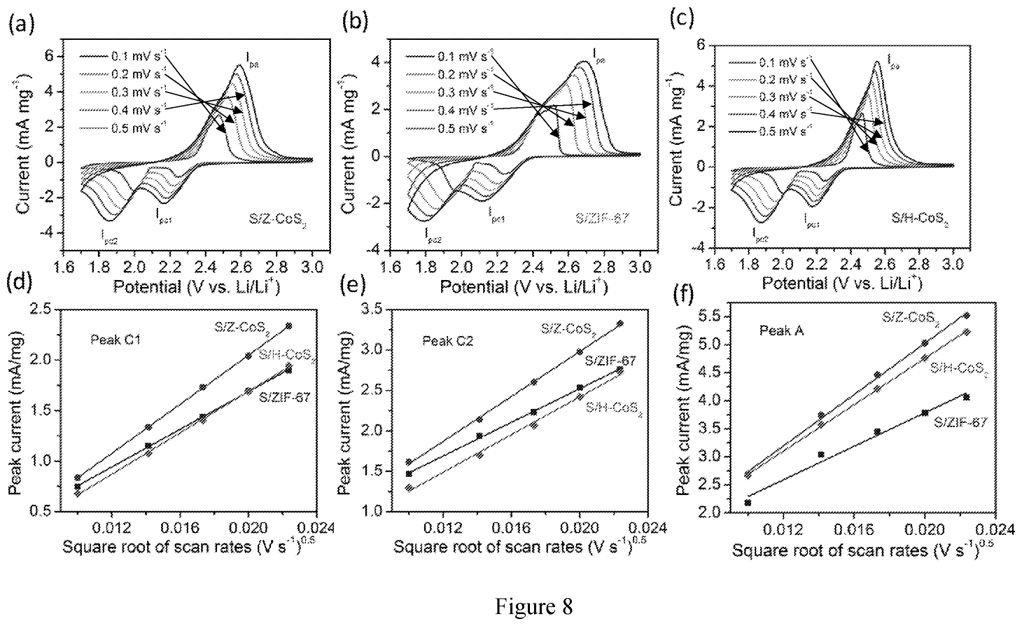

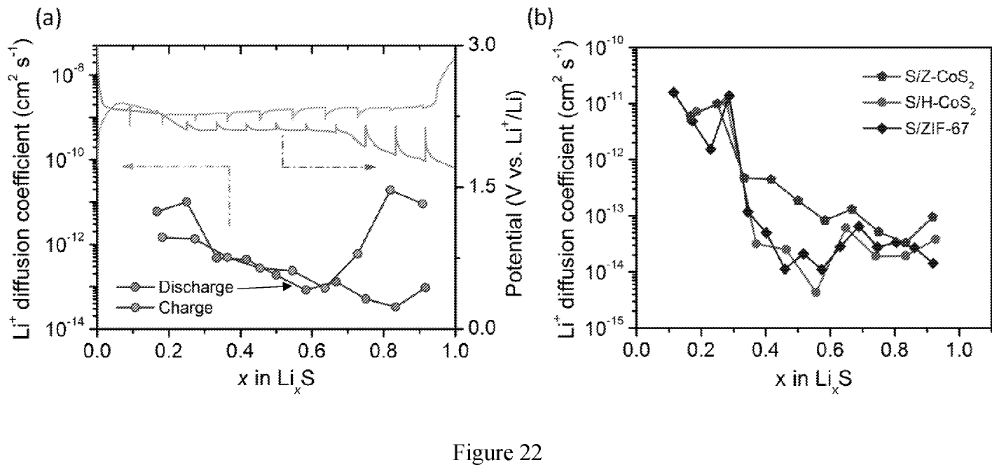

Furthermore, to study the reaction kinetics of the electrodes, the galvanostatic intermittent titration technique (GITT) was employed by discharging/charging the cell for 30 min at 0.1 C followed by a 10-hour rest period. The lithium ion diffusion coefficient at different states of charge (SOC), could be calculated from the transient voltage response using the expression developed by Weppner and Huggins. The lithium ion diffusion coefficients calculated using this equation at different SOC are plotted in FIGS. 22a and b. The values are found to be higher at the first discharge plateau than those at the second plateau, confirming that the reaction of S₈ to Li₂S₄ is faster than the transformation of Li₂S₄ to Li₂S, so the liquid-solid reaction is the rate-determining step in the sulfur reduction. Moreover, CV tests at different scan rates were further conducted to study the reaction kinetics of the electrodes (FIGS. 8a-c). At higher sweep rates, the potentials of the reduction peaks of S/Z-CoS₂ are the highest while those of the oxidation peaks are the lowest among S/Z-CoS₂, S/ZIF-67 and S/H-CoS₂, further indicating that the S/Z-CoS₂ composites have the fastest kinetics for the reaction between Li₂S and S₈. The Li⁺ diffusion coefficient can be derived by analyzing the CV data at different scan rates according to the Randles-Sevcik equation:

Iₚ=2.69×10⁵n^{3/2}AD^{1/2}Cν^{1/2}

where Iₚ is the peak current, n is the charge transfer number, A is the geometric area of the active electrode, D is the lithium ion diffusion coefficient, C is the concentration of Li⁺, and ν is the potential scan rate. The lithium ion diffusion coefficients can be determined by plotting the current density Iₚ, versus the square root of the scan rate ν^{1/2} (FIG. 8d-f). The linear relationship of Iₚ versus ν^{1/2} indicates that the reaction is a diffusion-controlled process. For Z-CoS₂ encapsulating sulfur electrode, the slopes are the highest among the three samples. For peak C1 (FIG. 8d), the diffusion rate increased by 29% and 34% for peak C2, respectively (FIG. 8e), compared to S/ZIF-67 electrodes. These results suggest that Z-CoS₂ could enhance the redox reaction kinetics, especially for the transformation from Li₂S₄ to Li₂S.

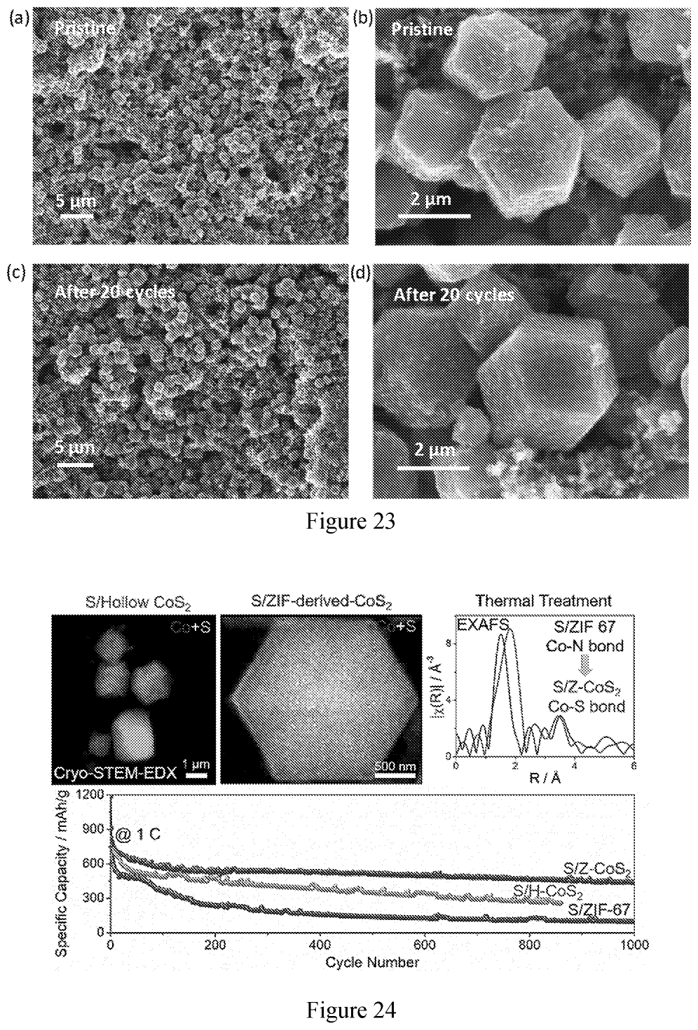

All of these results indicate that S/Z-CoS₂ is a promising sulfur cathode material for high energy density Li—S batteries with stable cycling life and outstanding rate performance. By comparing with other cathodes based on carbon, metal sulfides/oxides or MOF materials as hosts (Table 1), it is evident that the instant S/Z-CoS₂ exhibits enhanced rate capability and outstanding cycling stability. The improved performance is ascribed to various reasons. First, the heat treatment which produced a carbon framework, significantly increased the conductivity of the composite, increasing the utilization of active material during cycling and lowering the polarization in the coin cells. Second, the polar CoS₂ embedded in the carbon framework can provide strong adsorption to LiPSs, enriching the LiPSs concentration on the conductive host surface, thus accelerating the redox reaction. This has been verified by the adsorption test (FIG. 5). Third, in situ encapsulation of sulfur particles gives rise to an intimate contact between the host material and sulfur particles, and at the same time, provides a protective cage for physically restraining the LiPSs from diffusing into the electrolyte. The combined effects of physical confinement and chemical interactions give rise to the enhanced cycling stability. In addition to the physical and chemical entrapment of LiPSs, CoS₂ also serves as an electrocatalyst which can accelerate the polysulfides redox kinetics, especially for the liquid-solid state reaction, as manifested by the kinetic analysis (FIG. 8). It is also proposed that CoS₂ could control the precipitation of insoluble Li₂S. The SEM images of a fully discharged cell after 20 cycles displayed in FIG. 23 indicate that there are no bulk Li₂S particles present on the surface and the morphology of the composite has no noticeable changes, indicating the controlled precipitation and stable encapsulation of the active material.

TABLE 1
Comparison of electrochemical properties of S/Z-CoS₂ to other
reported carbon, metal oxides/sulfides, MOF as sulfur hosts.

| Materials | Rate performance | Cycling stability |
|---|---|---|
| S/Z-CoS₂ | 5 C, 430 mAh g⁻¹ | 0.2 C, 750 mAh g⁻¹, 200 cycles |
| | | 1 C, 440 mAh g⁻¹, 1000 cycles |
| Hierarchical | 2 C, 616 mAh g⁻¹ | 1 C, 558 mAh g⁻¹, 160 cycles |
| micro/mesoporous | | |
| carbonaceous | | |
| nanotube | | |
| MoO₂ | 2 C, 635 mAh g⁻¹ | 0.1 C, 570 mAh g⁻¹, 250 cycles |
| Ni-MOF | 2 C, 287 mAh g⁻¹ | 0.2 C, 520 mAh g⁻¹, 200 cycles |
| CoSx | 2 C, 525 mAh g⁻¹ | 0.1 C, 423 mAh g⁻¹, 100 cycles |
| CoS₂/graphene | 2 C, 1000 mAh g⁻¹ | 2 C, 320 mAh g⁻¹, 2000 cycles |
| CoS₂@G/CNT | 4 C, 480 mAh g⁻¹ | 0.5 C, 581 mAh g⁻¹, 300 cycles |
| Co₉S₈ | 2 C, 880 mAh g⁻¹ | 0.5 C, 250 mAh g⁻¹, 1500 cycles |
| Activated carbon | 2 C, 752 mAh g⁻¹ | 1 C, 610 mAh g⁻¹, 450 cycles |
| nanofiber/Co₃S₄ | | |

In conclusion, a facile and scalable method was developed to synthesize S/Z-CoS₂ composites via in situ encapsulation followed by heat treatment. The annealing process transformed ZIF-67 to CoS₂ embedded in a carbon framework. The formation of CoS₂ embedded in a carbon framework was confirmed by XAS and Cryo-TEM. The successful encapsulation of sulfur by ZIF-derived CoS₂ in a carbon matrix was examined through Cryo-S/TEM imaging together with EDX elemental mapping. It was demonstrated that the encapsulation of sulfur particles by CoS₂ embedded in a carbon framework is beneficial for preventing/precluding the LiPSs from diffusing into the electrolyte during cycling and can also accelerate the redox reactions. Benefitting from the improved conductivity, both physical entrapment of LiPSs and their chemical binding to CoS₂, and more importantly, accelerated redox kinetics induced by CoS₂ as an electrocatalyst, the resulting S/Z-CoS₂ could achieve a high areal capacity, excellent cycling stability and enhanced rate performance. This example provides valuable insights for novel and cost-effective sulfur host materials design for the practical application of high-energy, high-power and long-life Li—S batteries.

Although the present disclosure has been described with respect to one or more particular embodiments and/or examples, it will be understood that other embodiments and/or examples of the present disclosure may be made without departing from the scope of the present disclosure.

1. A metal-organic framework (MOF) comprising a plurality of sulfur nanoparticles encapsulated in the MOF.

2. The MOF of claim 1, wherein the sulfur nanoparticles have a size of 300 to 800 nm.

3. The MOF of claim 1, wherein the MOF comprises a plurality of metal ions.

4. The MOF of claim 1, wherein the MOF comprises an organic group comprising one or more functionality(ies) chosen from nitrogen-containing functionalities, oxygen-containing functionalities, sulfur containing functionalities, and combinations thereof.

5. The MOF of claim 1, wherein the MOF is chosen from MOFs comprising copper ions, MILs, and MOF-5, or
is a ZIF chosen from ZIFs comprising both Zn and Co ions and ZIFs comprising Zn ions.

6. The MOF of claim 1, wherein the sulfur nanoparticles are present at least at 70% by weight (based on the total weight of the MOF and sulfur nanoparticles).

7. The MOF of claim 1, wherein the MOF has a cubic, dodecahedral, spindle, octahedral, spherical, acicular, bladed, botryoidal, columnar, coxcomb, dendritic, enantiomorphic, equant, fibrous, hemimorphic, hexagonal, octahedral, platy, prismatic, pseudo-hexagonal, pyramidal, colloform, reticulated, lenticular, sphenoid, stellate, tetrahedral, wheat sheaf, tubular, or monolithic morphology.

8. The MOF of claim 1, wherein the MOF has a size of 0.1 micron to 10 microns.

9. A composition comprising a plurality of MOFs of claim 1.

10. The composition of claim 9, wherein the MOFs of the plurality of MOFs have the same nominal structure.

11. The composition of claim 9, wherein at least 2 of the MOFs of the plurality of MOFs have different nominal structure.

12. A method of making a MOF of claim 1 comprising:
forming a reaction mixture comprising:
sulfur nanoparticles,
a metal precursor, and
an organic ligand; and
holding the reaction mixture for a selected time, and, optionally, at a selected temperature,
wherein the MOF or composition is formed.

13. The method of claim 12, wherein the metal precursor is a metal salt, one or more metal oxide(s), or a combination thereof, wherein the metal salt is chosen from metal nitrate salts, metal acetate salts, metal formate salts, metal tetrafluoroborate salts, metal halide salts, metal oxychloride salts, metal sulfate salts, metal perchlorate salts, metal carbonate salts, metal oxalate salts, metal silicofluoride salts, metal acetylacetonate salts, metal benzoate salts, and metal formate salts, and combinations thereof.

14. The method of claim 12, wherein the organic ligand is chosen from nitrogen-containing ligands, oxygen-containing ligands, and sulfur-containing ligands.

15. A method of making a MOF comprising sulfur encapsulated in the MOF or a composition comprising a plurality of MOFs comprising sulfur encapsulated in the MOFs, the method comprising:
providing a MOF or a composition comprising a plurality of MOFs;
contacting the MOF or the composition comprising a plurality of MOFs with an acid to form MOFs with hollow structure;
contacting the MOF(s) with sulfur to form a mixture; and
heating the mixture,
wherein the MOF comprising sulfur encapsulated in the MOF or a composition comprising a plurality of MOFs comprising sulfur encapsulated in the MOFs is formed.

16. A composite material comprising a plurality of domains, each domain comprising:
a conducting carbon matrix;
a plurality of sulfur domains disposed within the carbon matrix; and
a plurality of metal sulfide domains disposed within the carbon matrix,
and, optionally, a plurality of sulfur domains not disposed within the conducting carbon matrix.

17. The composite material of claim 16, wherein the carbon matrix comprises a mixture of graphitic carbon and non-graphitic carbon.

18. The composite material of claim 16, wherein the carbon matrix has a spindle, cubic, dodecahedral, octahedral, spherical, acicular, bladed, botryoidal, columnar, coxcomb, dendritic, enantiomorphic, equant, fibrous, hemimorphic, hexagonal, octahedral, platy, prismatic, pseudo-hexagonal, pyramidal, colloform, reticulated, lenticular, sphenoid, stellate, tetrahedral, wheat sheaf, tubular, or monolithic morphology.

19. The composite material of claim 16, wherein the carbon matrix has a size of 0.1 micron to 10 microns.

20. The composite material of claim 16, wherein the sulfur domains and metal sulfide domains are in electrical contact with each other.

21. The composite material of any one of claims 16, wherein the sulfur domains are sulfur nanoparticles and the sulfur nanoparticles are present at least at 55% by weight (based on the total weight of the composite material).

22.-34. (canceled)
